(19) United States
(12) Patent Application Publication
(10) Pub. No.: US 2016/0235235 A1
(43) Pub. Date: Aug. 18, 2016

(54) Multipurpose Mat

(71) Applicant: Tom BURDEN, Toledo, OH (US)

(72) Inventor: Tom Burden, Toledo, OH (US)

(21) Appl. No.: 15/025,978

(22) PCT Filed: Oct. 1, 2014
(86) PCT No.: PCT/US14/58518

§ 371 Date: Mar. 30, 2016

Related U.S. Application Data
(60) Provisional application No. 61/932,921, filed on Jan. 29, 2014.
(60) Provisional application No. 61/885,582, filed on Oct. 2, 2013.

(51) Int. Cl. A47G 27/02; B60N 3/04

(52) U.S. Cl. CPC A47G 27/0206; B60N 3/044; B60N 3/046; B60N 3/048

(57) ABSTRACT

Multipurpose mats and hooks are described. An embodiment of a multipurpose mat comprises a mat body that defines a first side, a second side, a third side, a fourth side, a first surface, a second surface, a first set of projections, and a second set of projections. The wall extends from the first surface and away from the second surface a first distance. Each projection of the first set of projections extends from the first surface and away from the second surface a second distance. Each projection of the second set of projections extends from the first surface and away from the second surface a third distance that is less than the first distance and the second distance.

### RELATED APPLICATIONS

This application claims the benefit of U.S. Provisional Application No. 61/885,582, filed on Oct. 2, 2013, and U.S. Provisional Application No. 61/932,921, filed on Jan. 29, 2014. The disclosure of each of these related applications is hereby incorporated into this disclosure it its entirety.

### FIELD

This disclosure relates generally to the field of multipurpose mats and hooks for attaching a multipurpose mat to another object.

### BACKGROUND

A variety of multipurpose mats and attachment mechanisms have been developed to assist with the placement of one or more objects while a particular procedure is being completed. For example, some multipurpose mats have been developed that can be used during the repair of an automobile. However, a need exists for improved multipurpose mats and attachment mechanisms that can be used while a particular procedure is being completed.

### BRIEF SUMMARY OF SELECTED EXAMPLE EMBODIMENTS

An example embodiment of a multipurpose mat comprises a mat body that is formed of a pliable material. The mat body defines a first side, a second side, a third side, a fourth side, a first surface, a second surface, a wall, a first set of projections, and a second set of projections. The first surface has a perimeter that is defined by the first side, the second side, the third side, and the fourth side. The second surface is opposably facing the first surface. The wall extends about the perimeter of the first surface such that a first portion of the wall extends along the first side, a second portion of the wall extends along the second side, a third portion of the wall extends along the third side, and a fourth portion of the wall extends along the fourth side. The wall extends from the first surface and away from the second surface. The first set of projections comprises a first projection, a second projection, a third projection, and a fourth projection. Each projection of the first set of projections extends from the first surface and away from the second surface. Each of the first projection and the second projection extends from the first portion of the wall to the third portion of the wall. The third projection extends from the first projection to the second portion of the wall. The fourth projection extends from the third projection to the fourth portion of the wall. The second set of projections comprises a fifth projection, a sixth projection, a seventh projection, an eighth projection, and a ninth projection. Each projection of the second set of projections extends from the first surface and away from the second surface. Each of the fifth projection and the sixth projection extends from the first projection to the second projection. The seventh projection extends from the fifth projection to the sixth projection. The eighth projection extends from the first projection to the seventh projection. The ninth projection extends from the seventh projection to the second projection. The pliable material that forms the multipurpose mat is flexible such that the multipurpose mat can be moved from an open configuration in which the second side and the fourth side are parallel and a closed configuration in which the multipurpose mat is folded on an axis that is orthogonal to the lengthwise axis and the second portion of the wall and the fourth portion of the wall contact one another.

### BRIEF DESCRIPTION OF THE DRAWINGS

FIG. 1 is a perspective view of an example embodiment of a multipurpose mat.

FIG. 2 is a top view of the multipurpose mat illustrated in FIG. 1.

FIG. 3 is a front view of the multipurpose mat illustrated in FIG. 1.

FIG. 4 is an elevation view of the multipurpose mat illustrated in FIG. 1.

FIG. 5 is a top view of another example embodiment of a multipurpose mat.

FIG. 6 is a front view of the multipurpose mat illustrated in FIG. 5.

FIG. 7 is an elevation view of the multipurpose mat illustrated in FIG. 5.

FIG. 8 is a perspective view of another example embodiment of a multipurpose mat.

FIG. 9 is a front view of the multipurpose mat illustrated in FIG. 8.

FIG. 10 is a rear view of the multipurpose mat illustrated in FIG. 8.

FIG. 11 is an elevation view of the multipurpose mat illustrated in FIG. 8.

FIG. 12 is another elevation view of the multipurpose mat illustrated in FIG. 8.

FIG. 13 is a magnified perspective view of area A indicated in FIG. 12.

FIG. 14 is a top view of the multipurpose mat illustrated in FIG. 8.

FIG. 15 is a perspective view of an example embodiment of a hook that can be used in combination with a multipurpose mat.

FIG. 16 is an elevation view of the hook illustrated in FIG. 15.

FIG. 17 is a front view of the hook illustrated in FIG. 15.

FIG. 18 is a rear view of the hook illustrated in FIG. 15.

FIG. 19 is a perspective view of the hook illustrated in FIG. 15 releasably attached to the multipurpose mat illustrated in FIG. 8.

FIG. 20 is an elevation view of the multipurpose mat and associated hook illustrated in FIG. 19.

FIG. 21 is a perspective view of another example embodiment of a multipurpose mat.

FIG. 22 is another perspective view of the multipurpose mat illustrated in FIG. 21.

FIG. 23 is a front view of the multipurpose mat illustrated in FIG. 21.

FIG. 24 is an elevation view of the multipurpose mat illustrated in FIG. 21.

FIG. 25 is a perspective view of another example embodiment of a multipurpose mat.

FIG. 26 is a front view of the multipurpose mat illustrated in FIG. 25.

FIG. 27 illustrates an example workspace upon which a multipurpose mat or multipurpose mat and associated hook can be used.

FIG. 28 is a perspective view of another example embodiment of a multipurpose mat.

FIG. 29 is a front view of the multipurpose mat illustrated in FIG. 28.

FIG. 30 is a top view of the multipurpose mat illustrated in FIG. 28.

FIG. 31 is an elevation view of the multipurpose mat illustrated in FIG. 28.

FIG. 32 is a perspective view of another example embodiment of a multipurpose mat.

FIG. 33 is a front view of the multipurpose mat illustrated in FIG. 32.

FIG. 34 is a top view of the multipurpose mat illustrated in FIG. 32.

FIG. 35 is an elevation view of the multipurpose mat illustrated in FIG. 32.

FIG. 36 is a perspective view of another example embodiment of a multipurpose mat.

FIG. 37 is a front view of the multipurpose mat illustrated in FIG. 36.

FIG. 38 is a cross-sectional view of the multipurpose mat illustrated in FIG. 37, taken along line A-A.

FIG. 39 is a cross-sectional view of the multipurpose mat illustrated in FIG. 37, taken along line B-B.

FIG. 40 is a perspective view of another example embodiment of a multipurpose mat.

FIG. 41 is a front view of the multipurpose mat illustrated in FIG. 40.

FIG. 42 is a cross-sectional view of the multipurpose mat illustrated in FIG. 40, taken along line A-A.

FIG. 43 is a cross-sectional view of the multipurpose mat illustrated in FIG. 40, taken along line B-B.

FIG. 44 is a perspective view of another example embodiment of a multipurpose mat.

FIG. 45 is a front view of the multipurpose mat illustrated in FIG. 44.

FIG. 46 is a cross-sectional view of the multipurpose mat illustrated in FIG. 44, taken along line A-A.

FIG. 47 is a cross-sectional view of the multipurpose mat illustrated in FIG. 44, taken along line B-B.

### DETAILED DESCRIPTION

The following detailed description and the appended drawings describe and illustrate various example embodiments of multipurpose mats and hooks. The description and illustration of these examples are provided to enable one skilled in the art to make and use a multipurpose mat and/or hook. They are not intended to limit the scope of the claims in any manner.

The use of “e.g.,” “etc.,” “for instance,” “in example,” and “or” and grammatically related terms indicate non-exclusive alternatives without limitation, unless otherwise noted. The use of “optionally” and grammatically related terms means that the subsequently described element, event, feature, or circumstance may or may not be present or occur, and that the description includes instances where said element, event, feature, or circumstance occurs and instances where it does not. The use of “attached” refers to the fixed, releasable, or integrated association of two or more elements and/or devices. Thus, the term “attached” includes releasably attaching or fixedly attaching two or more elements and/or devices.

The use of “pliable” refers to the ability of a material to be bent, folded, twisted, manipulated, and/or adjusted by the hands of an average human being without the assistance of any tool or device between various configurations without damaging the element, feature, or object that the material forms.

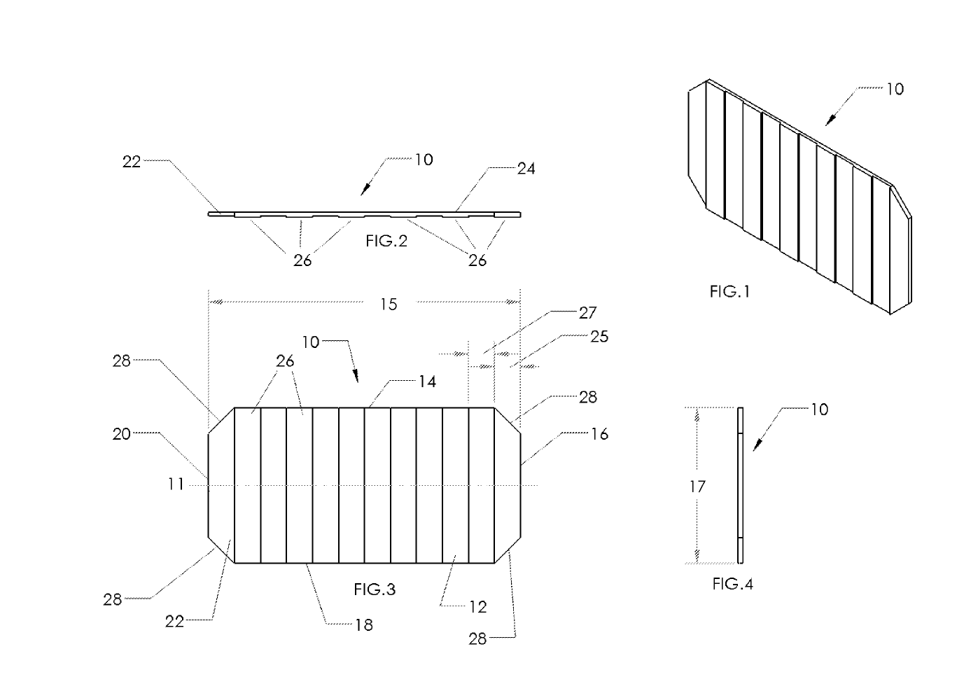

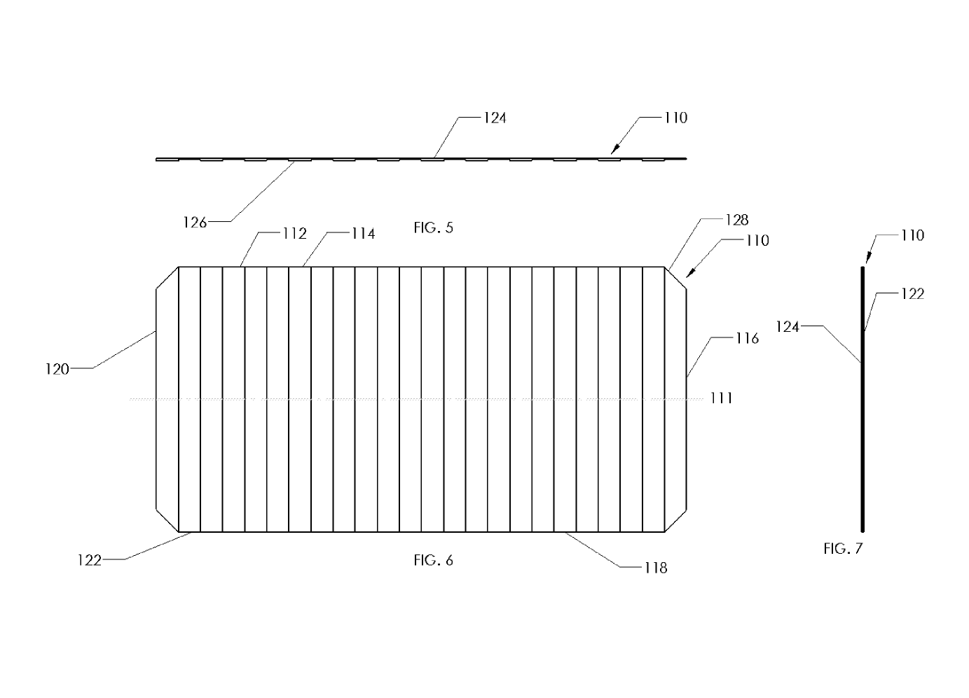

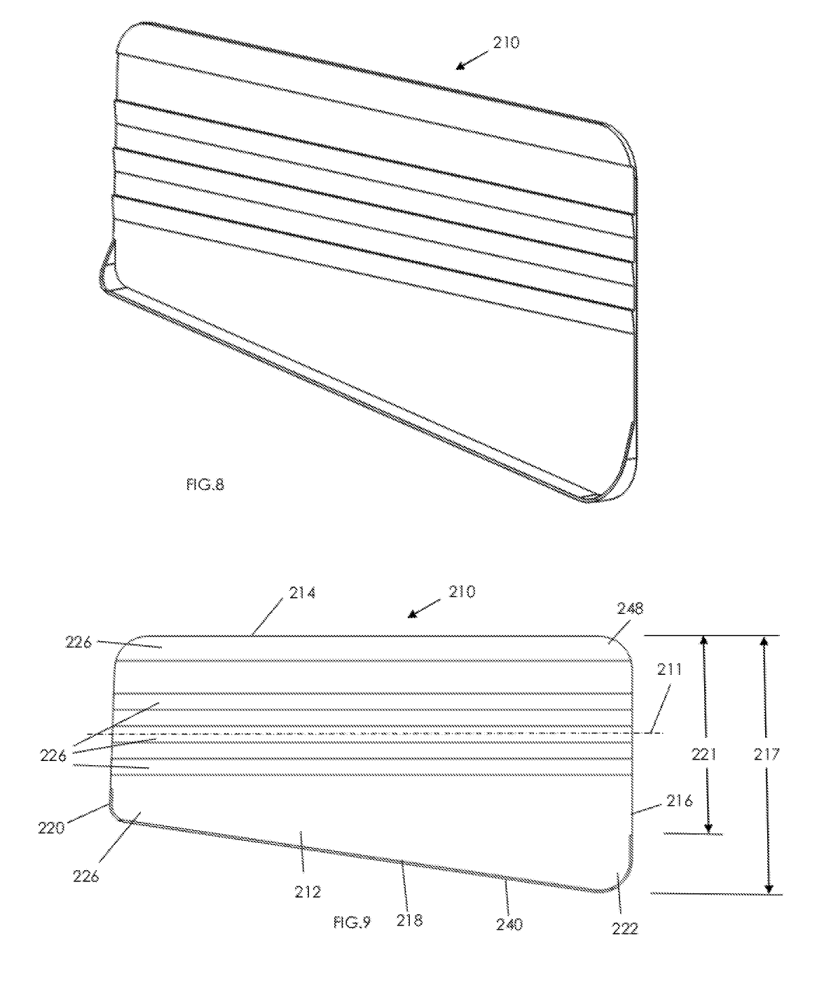

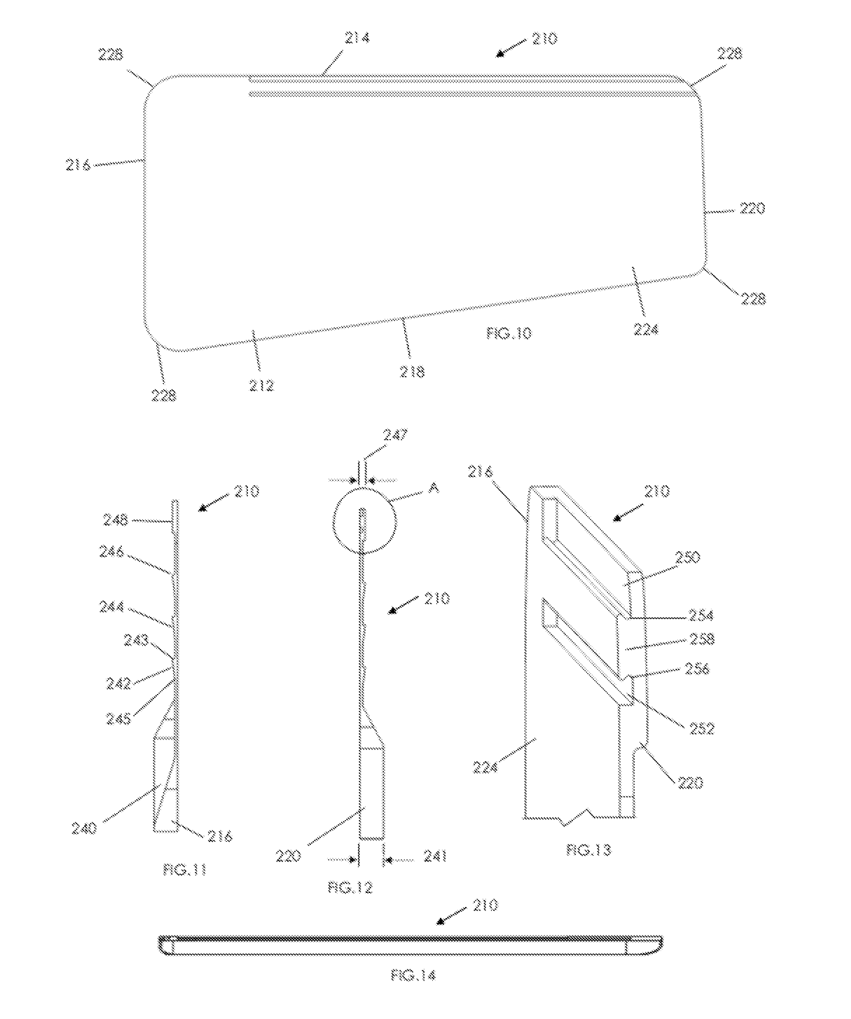

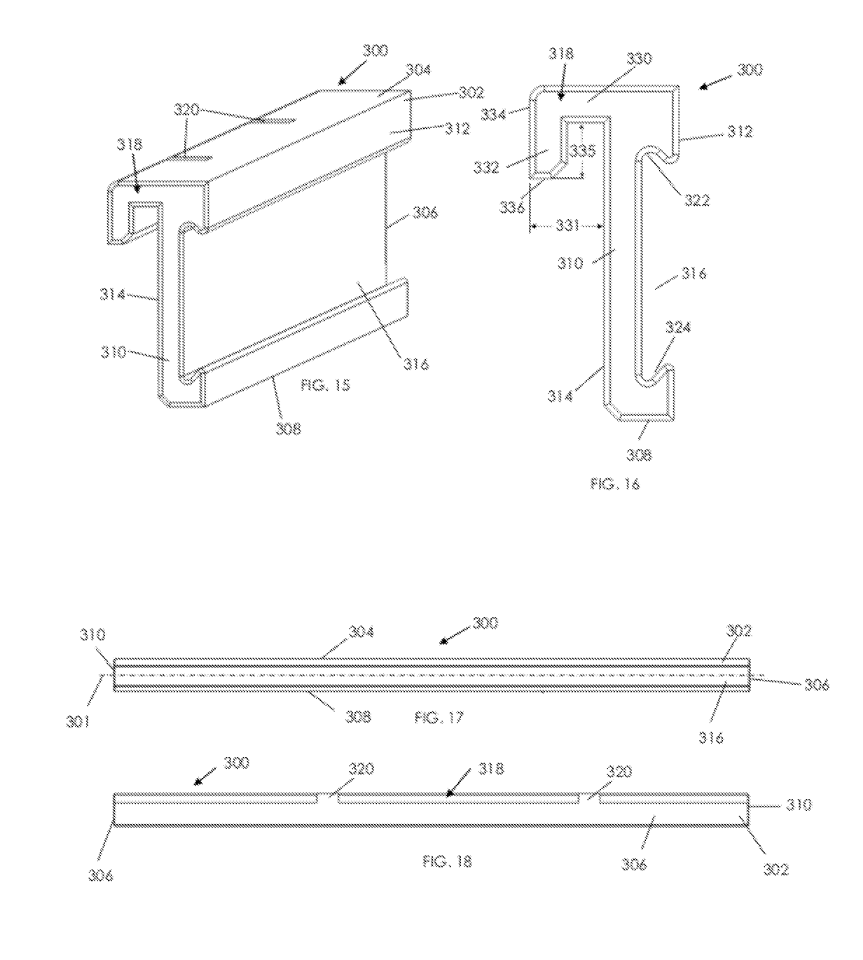

Each of FIGS. 1, 2, 3, and 4 illustrates an example embodiment of a multipurpose mat 10. The multipurpose mat 10 comprises a lengthwise axis 11 and a mat body 12 that defines a first side 14, a second side 16, a third side 18, a fourth side 20, a first surface 22, a second surface 24, projections 26, and chamfers 28.

The first side 14 extends from the second side 16 to the fourth side 20. The second side 16 extends from the first side 14 to the third side 18. The third side 18 extends from the second side 16 to the fourth side 20. The fourth side 20 extends from the first side 14 to the third side 18. In the illustrated embodiment, the mat body 12 defines a first chamfer 28 at a 45 degree angle between the first side 14 and the second side 16, a second chamfer 28 between the second side 16 and the third side 18, a third chamfer 28 between the third side 18 and the fourth side 20, and a fourth chamfer 28 between the first side 14 and the fourth side 20.

In the illustrated embodiment, the first side 14 is parallel to the third side 18 and the second side 16 is parallel to the fourth side 20. However, alternative embodiments of a multipurpose mat can include a first side that is not parallel to a third side and/or a second side that is not parallel to a fourth side. For example, alternative embodiments can include a side that is disposed at an angle to another side and/or a side that is non-planar (e.g., the side is curved). Each of the first side 14 and third side 18 has a length 15 equal to about 24 inches that extends from the second side 16 to the third side 20. Each of the second side 16 and fourth side 20 has a length 17 equal to about 12 inches that extends from the first side 14 to the third side 18.

Thus, the first side 14 and the third side 18 have the same length and the second side 16 and the fourth side 20 have the same length. The first side 14 has a length 15 that is different than the length 17 of the second side 16. While a first side 14, a second side 16, a third side 18, and a fourth side 20 have been illustrated, a multipurpose mat can include any suitable number of sides and can form any suitable geometric shape. Skilled artisans will be able to select a suitable number of sides to include on a multipurpose mat according to a particular embodiment based on various considerations, including the intended use of the multipurpose mat. Example number of sides considered suitable to include on a multipurpose mat include one, at least one, two, a plurality, three, four, five, six, seven, eight, and any other number considered suitable for a particular embodiment.

While the multipurpose mat 10 has been illustrated as including four chamfers 28, each disposed at a 45 degree angle, a multipurpose mat can include any suitable number of chamfers disposed at any suitable angle. Example number of chamfers considered suitable to include on a multipurpose mat include one, at least one, two, a plurality, three, four, five, six, and any other number considered suitable for a particular embodiment. Example angles considered suitable to define a chamfer, or other feature, on a multipurpose mat include angles equal to, substantially equal to, about, less than, or greater than 45 degrees, 35 degrees, 25 degrees, 15 degrees, and any other angle considered suitable for a particular embodiment. Alternatively, a multipurpose mat can omit the inclusion of a chamfer and/or include other structural features as an alternative to a chamfer, such as a beveled edge, rounded edge, square edge, curved edge, or any other feature considered suitable for a particular embodiment.

Each of the first surface 22 and second surface 24 has a perimeter defined by the first side 14, second side 16, third side 18, and fourth side 20. In the illustrated embodiment, the perimeter of each of the first surface 22 and the second surface 24 is entirely defined by the first side 14, second side 16, third side 18, and fourth side 20, which include the illustrated chamfers 28. However, alternative embodiments can include a first surface and/or second surface that are only partially defined by the sides of a multipurpose mat. In the illustrated embodiment, the first surface 22 is opposably facing the second surface 24. However, alternative embodiments can include a first surface that is substantially opposably facing a second surface, or that is not opposably facing a second surface.

Each of the projections 26 extends from the first surface 22 and away from the second surface 24. In the illustrated embodiment, the lengthwise axis of each projection 26 is disposed orthogonal to a plane that contains the lengthwise axis 11 of the multipurpose mat 10. Thus, all of the projections 26 are parallel to one another. However, alternative embodiments can include a first projection that is not parallel to a second projection, or a first set of projections that is not parallel to a second set of projections. Each projection 26 has a length 25 equal to about 2 inches that is measured on an axis that is parallel to the lengthwise axis 11 of the multipurpose mat 10. Each projection 26 is separated from an adjacent projection 26 by a distance 27 equal to about 2 inches that is measured on an axis that is parallel to the lengthwise axis 11 of the multipurpose mat 10. While six projections 26 have been illustrated, a multipurpose mat can include any suitable number of projections, such as one, at least one, two, a plurality, three, four, five, six, seven, eight, a first set of projections, a second set of projections, and any other number considered suitable for a particular embodiment. Alternatively, a multipurpose mat can omit the inclusion of a projection.

While the projections 26 have been illustrated as having a rectangular cross-sectional configuration taken along a plane that contains the lengthwise axis 11 of the multipurpose mat 10 and that is disposed parallel to the first side 14, a projection included on a multipurpose mat can have any suitable cross-sectional configuration. For example, the cross-sectional configuration of a projection taken along any suitable plane, such as one that contains the lengthwise axis of a multipurpose mat and that is parallel to the first side, can be curved, semicircular, semi-spherical, rectangular, square, or any other configuration considered suitable for a particular embodiment. In addition, while the projections 26 have been illustrated as formed from the body 12 of the multipurpose mat, a wall or projection of an embodiment described herein can be either an integrated component of the multipurpose mat or a separate element attached to the multipurpose mat using any suitable method of attachment, such as an adhesive.

Alternative embodiments can include one or more projections that extend from the second surface and away from the first surface. Each projection that extends from the second surface can have a width that is equal to, substantially equal to, about, greater than, or less than the width of a projection that extends from the first surface. Each projection that extends from the second surface can be disposed such that the lengthwise axis of the projection is disposed on a plane, or parallel to a plane, that contains the lengthwise axis of a projection that extends from the first surface and is orthogonal to the lengthwise axis of the multipurpose mat.

Any suitable material can be used to form a multipurpose mat, and skilled artisans will be able to select a suitable material according to a particular embodiment based on various considerations, including the material(s) that forms the surface on which the multipurpose mat is intended to be used. Example materials considered suitable to form a multipurpose mat include plastics, polymers, silicone, silicone-based materials, rubber, polyethylene, synthetic materials, pliable materials, flexible materials, semi-rigid materials, rigid materials, materials that provide a degree of attachment (e.g., releasable attachment) between an element placed on a multipurpose mat and the multipurpose mat, materials that provide a degree of attachment between a multipurpose mat and a surface upon which the multipurpose mat is intended to be used such that the multipurpose mat is releasably attached to the surface upon which the multipurpose mat is intended to be used, combinations of the materials described herein, and any other material considered suitable for a particular application.

A multipurpose mat can be formed of a material that is pliable such that the multipurpose mat can be moved between a first, open, configuration in which the edge between the first surface and the second side and the edge between the first surface and the fourth side are parallel to one another, substantially parallel to one another, and/or not contacting one another and a second, closed, configuration in which the edge between the first surface and the second side and the edge between the first surface and the fourth side are not parallel to one another and/or contact one another. Additionally, or alternative to the configurations described above, a multipurpose mat can be formed of a material that is pliable such that the multipurpose mat can be moved between a first, open, configuration in which the edge between the first surface and the first side and the edge between the first surface and the third side are parallel to one another, substantially parallel to one another, and/or not contacting one another and a second, closed, configuration in which the edge between the first surface and the first side and the edge between the first surface and the third side are not parallel to one another and/or contact one another. For example, a multipurpose mat can be formed of a pliable material such that the multipurpose mat can be folded. In the second configuration, the second surface of a multipurpose mat will form a teardrop configuration. For example, when the edge between the first surface and the first side and the edge between the first surface and the third side are brought into contact with one another, each of the second and fourth sides will be curved and form a teardrop configuration. Alternatively, when the edge between the first surface and the second side and the edge between the first surface and the fourth side are brought into contact with one another, each of the first and third sides will be curved and form a teardrop configuration.

When a multipurpose mat is formed of a pliable material, it is configured to conform the second surface of the multipurpose mat to the structural configuration of the surface on which the multipurpose mat is disposed without any external forces being applied to the multipurpose mat (e.g., the second surface of the multipurpose mat will form a negative of the surface on which it is placed). For example, when a multipurpose mat is disposed on the surface of an airplane, or jet, such as an airfoil (e.g., wing of an airplane, or jet), the second surface of the multipurpose mat is configured to conform to the surface of the airplane or jet without external forces being applied to the multipurpose mat. In embodiments in which a multipurpose mat is disposed on a surface, such as an airfoil, such as the wing of an airplane or a jet, the surface can comprise any suitable surface and have any structural configuration, and skilled artisans will be able to select a suitable surface to position a multipurpose mat according to a particular embodiment based on various considerations, including the intended use of the multipurpose mat. Examples of suitable surfaces considered suitable to position a multipurpose mat include flat surfaces, non-flat surfaces, curved surfaces, surfaces that define one or more openings and/or recesses, curved airfoils, and any other surface considered suitable for a particular embodiment.

When a multipurpose mat is positioned on a surface, one or more objects, tools, and/or devices can be positioned on the multipurpose mat. For example, when a multipurpose mat is disposed on a non-flat surface and one or more objects, tools, and/or devices (e.g., objects, tool, and/or devices that are rigid relative to the multipurpose mat) are disposed on the multipurpose mat, such as on the first surface, one or more projections, a wall, the one or more objects, tools, and/or devices, unless formed of a pliable material, will not conform to the structural configuration of the surface on which the multipurpose mat is disposed. Thus, the multipurpose mat will have a first configuration and the one or more objects, tools, and/or devices will have a second configuration that is different than the first configuration.

The material that forms a multipurpose mat can have any suitable durometer hardness and skilled artisans will be able to select a material to form a multipurpose mat that has a suitable durometer hardness according to a particular embodiment based on various considerations, including the intended use of the multipurpose mat. Examples of suitable durometer hardnesses considered suitable for a material that forms a multipurpose mat include materials that have a durometer hardness equal to, substantially equal to, about, less than, or greater than, a 40 durometer hardness, a 60 durometer hardness, a durometer hardness between 40 and 60, and materials that have any other durometer hardness considered suitable for a particular application. Any suitable scale can used to measure the durometer hardness of a material, such as the Shore A and Shore D scales.

A multipurpose mat can be formed using any suitable technique, and skilled artisans will be able to select a suitable technique to form a multipurpose mat according to a particular embodiment based on various considerations, including the material(s) that forms the multipurpose mat. Example techniques considered suitable to form a multipurpose mat include injection molding and/or cast molding.

A multipurpose mat can be formed of a material having any suitable color, and skilled artisans will be able to select a suitable color for a multipurpose mat according to a particular embodiment based on various considerations, including the intended use of the multipurpose mat. Example colors considered suitable to form a multipurpose mat include, but are not limited to, green, yellow, grey, brown, white, black, red, blue, and any other color considered suitable for a particular application. A multipurpose mat can optionally be formed of a color that is based on the material that forms the multipurpose mat, the type of surface on which the multipurpose mat is intended to be used (e.g., the type of material that forms the surface on which the multipurpose mat is intended to be used), the coefficient of friction between the multipurpose mat and the surface on which the multipurpose mat is intended to be used, and/or on the color of the surface on which the multipurpose mat is intended to be used. For example, if the multipurpose mat is formed of rubber, the material that forms the multipurpose mat can be colored green. Alternatively, if the multipurpose mat is formed of a synthetic material, the material that forms the multipurpose mat can be colored red. In embodiments in which the color of the material that forms the multipurpose mat is based on the color of the surface on which the multipurpose mat is intended to be used, the material that forms the multipurpose mat can be different than the color of the surface on which the multipurpose mat is intended to be used. For example, the multipurpose mat can be formed of a material that provides a high degree of contrast between the multipurpose mat and the surface on which the multipurpose mat is intended to be used.

In the illustrated embodiment, example dimensions for various structural elements of the multipurpose mat 10 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described. For example, any of the edges described and/or illustrated herein can have a radius of curvature or chamfer, such as a radius of curvature equal to about 0.06 inches or 0.05 inches, or a chamfer equal to about 2.0 inches or 0.03 inches.

For example, a first side and third side of a multipurpose mat can have a length equal to, substantially equal to, about, less than, or greater than 24 inches and a second side and fourth side of a multipurpose mat can have a length equal to, substantially equal to, about, less than, or greater than 12 inches. Alternative embodiments can include a first side than has a length that is different than the length of a third side and/or a second side that has a length that is different than a fourth side. A projection and/or the space between adjacent projections included on a multipurpose mat can have a length that is equal to, substantially equal to, about, less than, or greater than 2 inches. Alternative to the configuration illustrated and described, a first projection can have a first length and a second projection can have a second length that is different than the first length and/or a first projection can be separated from an adjacent projection a first distance and a third projection can be separated from a fourth projection by a second distance that is different than the first distance.

Each of FIGS. 5, 6, and 7 illustrates another example embodiment of a multipurpose mat 110. Multipurpose mat 110 is similar to multipurpose mat 10 illustrated in FIGS. 1, 2, 3, and 4 and described above, except as detailed below. Reference numbers in FIGS. 5, 6, and 7 refer to the same structural element or feature referenced by the same number in FIGS. 1, 2, 3, and 4, offset by 100. Thus, multipurpose mat 110 comprises a lengthwise axis 111 and a mat body 112 that defines a first side 114, a second side 116, a third side 118, a fourth side 120, a first surface 122, a second surface 124, projections 126, and chamfers 128.

In the illustrated embodiment, each of the first side 114 and the third side 118 has a length equal to about 48 inches that extends from the second side 116 to the fourth side 120 and each of the second side 116 and the fourth side 120 has a length equal to about 24 inches that extends from the first side 14 to the third side 18. In addition, the multipurpose mat 110 includes twelve projections 126. Each projection 126 is disposed from an adjacent projection 126 by a distance equal to about 2 inches measured on an axis that is parallel to the lengthwise axis 111 of the multipurpose mat 110.

In the illustrated embodiment, example dimensions for various structural elements of the multipurpose mat 110 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described.

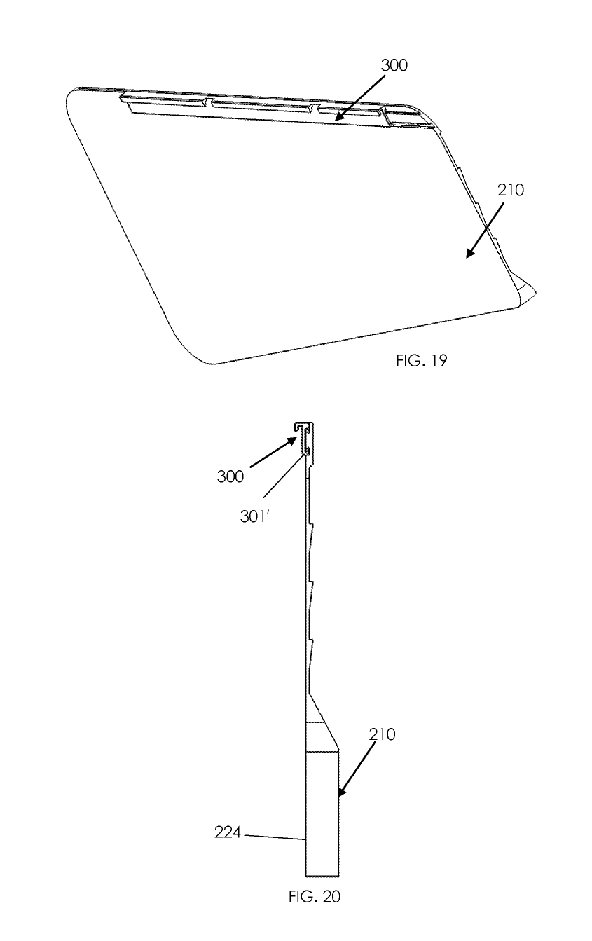

Each of FIGS. 8, 9, 10, 11, 12, 13, and 14 illustrates another example embodiment of a multipurpose mat 210. Multipurpose mat 210 is similar to multipurpose mat 10 illustrated in FIGS. 1, 2, 3, and 4 and described above, except as detailed below. Reference numbers in FIGS. 8, 9, 10, 11, 12, 13, and 14 refer to the same structural element or feature referenced by the same number in FIGS. 1, 2, 3, and 4, offset by 200. Thus, multipurpose mat 210 comprises a lengthwise axis 211 and a mat body 212 that defines a first side 214, a second side 216, a third side 218, a fourth side 220, a first surface 222, a second surface 224, and projections 226.

In the illustrated embodiment, multipurpose mat 210 omits the inclusion of chamfers (e.g., chamfers 28) and includes rounded corners 228 between the first side 214 and second side 216, the second side 216 and the third side 218, the third side 218 and the fourth side 220, and the fourth side 220 and the first side 214. The rounded corners included on a multipurpose mat can have any suitable radius of curvature, such as a radius of curvature that is equal to, substantially equal to, about, greater than, or less than 1.0 inch, 2.0 inches, and any other radius of curvature considered suitable for a particular embodiment. Alternatively, rounded corners 228 can be omitted and a multipurpose mat can be formed such that a first side is perpendicular to a second side, a second side is perpendicular to a third side, a third side is perpendicular to a fourth side, and/or a fourth side is perpendicular to a first side.

In the illustrated embodiment, second side 216 has a first length 217 and fourth side 220 has a second length 221. The first length 217 is greater than the second length 221. Thus, the length of the multipurpose mat 210 tapers from the second side 216 to the fourth side 220. In the illustrated embodiment, the length of the second side 216 is equal to about 15.68 inches that extends from the first side 214 to the third side 218, the length of the fourth side 220 is equal to about 11.39 inches that extends from the first side 214 to the third side 218, and the multipurpose mat 210 has a length 215 that extends from the second side 216 to the fourth side 220 that is equal to about 31.97 inches as measured on an axis that is parallel to the lengthwise axis 211. In the illustrated embodiment, the fourth side 220 is disposed at a 2.0 degree angle relative to an axis that is orthogonal to the lengthwise axis 211.

The mat body 212 defines a first projection 240, a second projection 242, a third projection 244, a fourth projection 246, a fifth projection 248, a first recess 250, and a second recess 252.

Each of the first projection 240, second projection 242, third projection 244, fourth projection 246, and fifth projection 248 extends from the first surface 222 and away from the second surface 224. The first projection 240 extends along the entire edge of the first surface 222 and the third side 218 and extends along a portion of the edge of the first surface 222 and the second side 216 and along a portion of the edge of the first surface 222 and the fourth side 220. Alternatively, a first projection can be disposed along a portion of an edge of a multipurpose mat or can be entirely disposed on the first surface such that is does not contact an edge of a multipurpose mat. In the illustrated embodiment, the first projection 240 extends along a portion of the edge of the first surface 222 and the second side 216 a length equal to about 3.51 inches that extends from the third side 218 toward the first side 214 and extends along a portion of the edge of the first surface 222 and the fourth side 220 a length equal to about 2.01 inches that extends from the third side 218 toward the first side 214.

In the illustrated embodiment, the thickness of the multipurpose mat 210 that extends from the first surface 222 to the second surface 224 is equal to about 0.125 inches. The thickness of the multipurpose mat 210 that extends from the second surface 224 to the outer edge of the first projection 240 is equal to about 1.0 inch. Alternatively, the thickness of a multipurpose mat that extends from the second surface to the outer edge of a first projection can be equal to about 1.125 inches, or any other suitable length.

Each of the second projection 242, the third projection 244, and the fourth projection 246 is disposed between the first projection 240 and the fifth projection 248. Each of the second projection 242, the third projection 244, and the fourth projection 246 has a thickness that tapers from a first end 243 to a second end 245 and has a length that extends from the first end 243 to the second end 245 that is equal to about 1.0 inch. The second projection 242 is disposed between the first projection 240 and the third projection 244. The third projection 244 is disposed between the second projection 242 and the fourth projection 246. The fourth projection 246 is disposed between the third projection 244 and the fifth projection 248 and is disposed from the fifth projection 248 a distance equal to about 2.0 inches. Each of the second projection 242, the third projection 244, and the fourth projection 246 extends from the edge of the first surface 222 and the second side 216 to the edge of the first surface 222 and the fourth side 220. The second projection 242 is parallel to the third projection 244 and the third projection 244 is parallel to the fourth projection 246. However, alternative embodiments of a multipurpose mat can include a first projection that is disposed at any suitable angle to a second projection and/or one or more projections that are disposed between the edge of the first surface and the second side and the edge of the first surface and the fourth side. In the illustrated embodiment, each of the second projection 242, the third projection 244, and the fourth projection 246 has an apex that has a radius of curvature equal to about 0.05 inches.

The fifth projection 248 extends along the entire edge of the first surface 222 and the first side 214 and extends along a portion of the edge of the first surface 222 and the second side 216 and along a portion of the edge of the first surface 222 and the fourth side 220. Alternatively, a fifth projection can be disposed along a portion of an edge of a multipurpose mat or can be entirely disposed on the first surface such that is does not contact an edge of a multipurpose mat. In the illustrated embodiment, the fifth projection 248 has a length that extends from the first side 214 and toward the third side 218 that is equal to about 1.5 inches.

In the embodiment illustrated, the first projection 240 extends from the first surface 222 and away from the second surface 224 a first length 241 and each of the second projection 242, the third projection 244, the fourth projection 246, and the fifth projection 248 extends from the first surface 222 and away from the second surface 224 a second length 247. The first length 241 is greater than the second length 247. In the illustrated embodiment, the second length 247 is equal to about 0.25 inches.

Each of the first recess 250 and second recess 252 extends from the second surface 224, into the body 212 of the multipurpose mat 210, and into the fifth projection 248. In the illustrated embodiment, each of the first recess 250 and the second recess 252 extends into the body 212 from the second surface 224 toward the first surface 222 a distance equal to about 0.125 inches. However, alternative embodiments can include a first recess and a second recess that extend only into the body of the multipurpose mat. The first recess 250 also extends from the first side 214 and into the body 212 of the multipurpose mat 210 toward the third side 218. Each of the first recess 250 and second recess 252 is sized and configured to receive a portion of hook 300, as described in more detail below.

Each of the first recess 250 and second recess 252 extends from the fourth side 220 toward the second side 216 and terminates at a location between the fourth side 220 and the second side 216. In the illustrated embodiment, the lengthwise axis of the first recess 250 is parallel to the lengthwise axis of the second recess 252. Each of the first recess 250 and second recess 252 terminates a distance from the second side 216 equal to about 5.0 inches. This structural arrangement provides a mechanism for positioning the hook 300 at a desired location along the length of multipurpose mat 210 and provides a mechanical stop to advancement of the hook 300 into the multipurpose mat 210. The first recess 250 interrupts the second surface 224 by creating an opening that extends from the first side 214 toward the third side 218 a length equal to about 0.30 inches measured along the fourth side 220. The second recess 252 interrupts the second surface 224 by creating an opening that is disposed between the opening created by the first recess 250 and the third side 218 that has a length equal to about 0.18 inches measured along the fourth side 220.

Each of the first recess 250 and second recess 252 can define any suitable configuration such that hook 300 is capable of slidable engagement with multipurpose mat 210 and releasable attachment to multipurpose mat 210. In the illustrated embodiment, first recess 250 defines a first curved surface 254 along the length of first recess 250 and second recess 252 defines a second curved surface 256 along the length of second recess 252. In the illustrated embodiment, each of the first curved surface 254 and the second curved surface 256 has a radius of curvature equal to about 0.03 inches. In combination, the first recess 250 and the second recess 252 define a projection 258 that extends from the fourth side 220 toward the second side 216. The projection 258 is sized and configured to be received by recess 316 defined by hook 300, as described below. The projection 258 has a configuration that tapers from the second surface 224 toward the first surface 222. Each taper of the projection 228 extends at an angle equal to about 45 degrees relative to a plane that contains the second surface 224. At the second surface 224, the projection 228 has two ends that have a radius of curvature equal to about 0.02 inches. The projection has a length that extends from the first recess 250 to the second recess 252 that is equal to about 0.645 inches.

While two recesses 250, 252 have been illustrated, a multipurpose mat can include any suitable number of recesses, such as one, at least one, two, a plurality, three, four, five, six, seven, eight, and any other number considered suitable for a particular embodiment. While each of the first recess 250 and second recess 252 has been described as extending from the fourth side 220 toward the second side 216, a recess can extend from any suitable portion of a multipurpose mat. For example, a recess can extend from the second side toward the fourth side, or from any other location considered suitable for a particular embodiment.

In the illustrated embodiment, example dimensions for various structural elements of the multipurpose mat 210 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described.

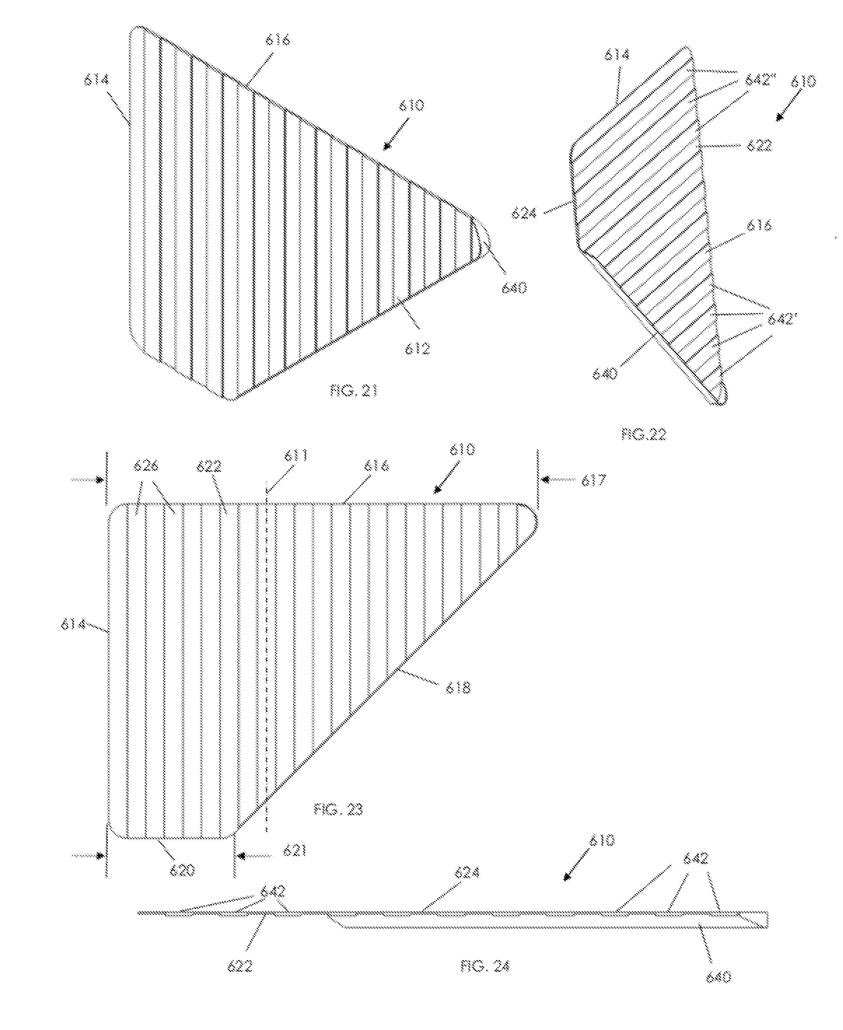

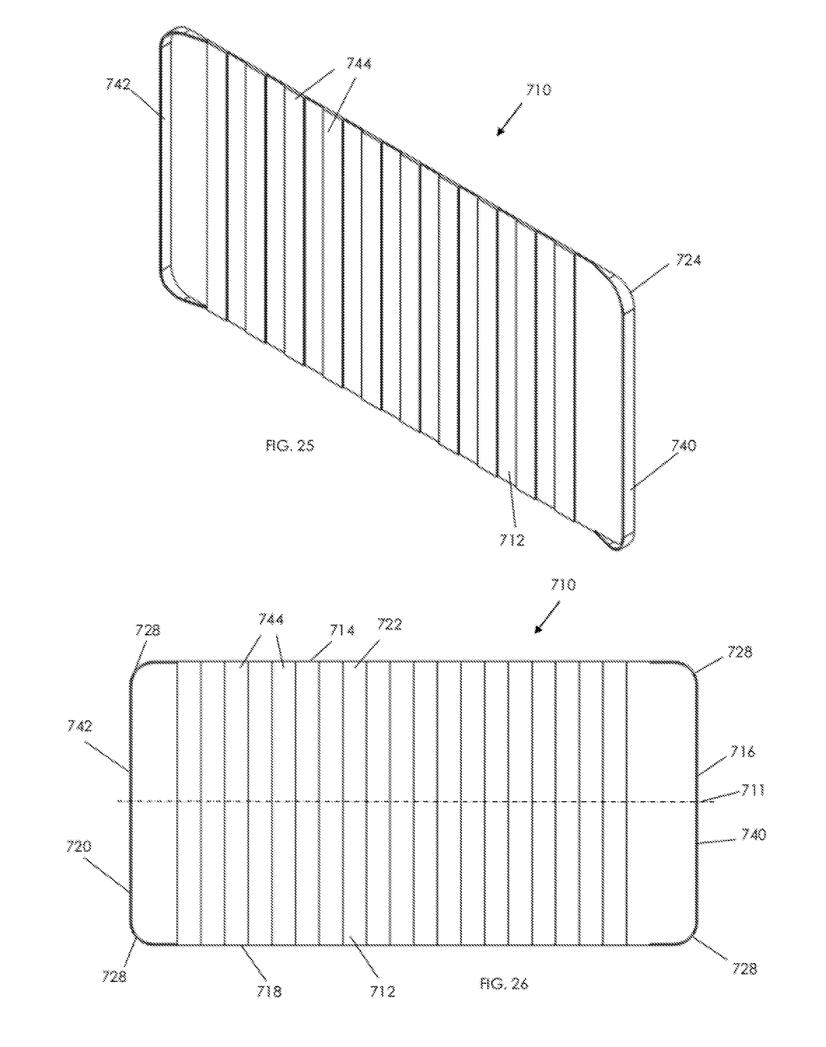

Each of FIGS. 15, 16, 17, and 18 illustrates an example embodiment of a hook 300 that can be used with a multipurpose mat, such as multipurpose mat 210. Hook 300 comprises a lengthwise axis 301 and an elongate body 302 that defines a first side 304, a second side 306, a third side 308, a fourth side 310, a first surface 312, a second surface 314, a recess 316, a projection 318, and notches 320.

In the illustrated embodiment, the first surface 312 is opposably facing the second surface 314 such that the hook 300 has a thickness that extends from the first surface 312 to the second surface 314 that is equal to about 0.25 inches. The hook 300 has a length that extends from the second side 306 to the fourth side 310 that is equal to about 22 inches and has a length that extends from the first side 304 to the third side 308 that is equal to about 1.125 inches.

Recess 316 extends into the elongate body 302 from the first surface 312 toward the second surface 314 and from the second side 306 to the fourth side 310. The recess 316 extends from the first surface 312 and into the body 302 of the hook 300 a distance equal to about 0.125 inches. Recess 316 is sized and configured to receive the projection 258 defined by multipurpose mat 210. Recess 316 defines a first curved surface 322 and a second curved surface 324. The first curved surface 322 is complementary to first curved surface 254 and the second curved surface 324 is complementary to second curved surface 256. In the illustrated embodiment, each of the first curved surface 322 and second curved surface 324 has a radius of curvature equal to about 0.02 inches and the two edges between the first surface 312 and the recess 316 have a radius of curvature equal to about 0.03 inches. In the illustrated embodiment, the first surface 312 extends from the first side 304 toward the third side 308 a distance equal to about 0.30 inches to recess 316 and extends from the recess 316 to the third side 308 a distance equal to about 0.18 inches. The recess 316 tapers from the base of the recess 316 toward the first surface 312 such that each side of the recess is disposed at a 45 degree angle relative to a plane that contains the first surface 312.

Projection 318 has a first portion 330 and a second portion 332. The first portion 330 extends from the second surface 314 and away from the first surface 312 to a first projection end 334 a length 331 that is equal to about 0.25 inches. The first portion 330 has a thickness equal to about 0.125 inches that extends from the first side 304 toward the third side 308. The second portion 332 extends from the first projection end 334 toward the third side 308 to a second projection end 336 a length that is equal to about 0.1875 inches. The second portion 332 has a thickness equal to about 0.125 inches that extends from the first projection end 334 toward the second surface 314. The second portion 332 extends from the first projection end 334 parallel to the second surface 314. However, other angles are considered suitable.

Each notch 320 extends through the first portion 330 and second portion 332 of the projection 318 and into the elongate body 302 such that the surfaces of the first portion 330 and the second portion 332 of the projection 318 and the surface of the first side 303 are interrupted. However, a notch can have any suitable depth. For example, a notch can extend through a portion, or the entirety, of a first portion of a projection, a second portion of a projection, and/or an elongate body. While two notches 320 have been illustrated, any suitable number of notches can be included on a hook, such as one, at least one, two, a plurality, three, four, five, and any other number considered suitable for a particular application. Alternatively, notches can be omitted from a multipurpose mat.

A first notch 320 is disposed a distance from the fourth side 310 equal to about 5.125 inches and a second notch 320 is disposed a distance from the fourth side 310 equal to about 14.185 inches. In the illustrated embodiment, each notch 320 has a length measured on an axis parallel to the lengthwise axis 301 of the hook 300 that is equal to about 0.75 inches.

Any suitable material can be used to form a hook, and skilled artisans will be able to select a suitable material to form a hook according to a particular embodiment based on various considerations, including the material(s) that forms the surface on which the hook is intended to be used. Example materials considered suitable to form a hook include plastics, polymers, silicone-based materials, rubber, polyethylene, flexible materials, rigid materials, and any other material considered suitable for a particular application. For example, a hook can be formed of a first material and a multipurpose mat intended to be releasably attached to the hook can be formed of a second material that is the same as, or different than, the first material.

A hook can be formed using any suitable technique, and skilled artisans will be able to select a suitable technique to form a hook according to a particular embodiment based on various considerations, including the material(s) that forms the hook. An example technique considered suitable includes injection molding.

In the illustrated embodiment, example dimensions for various structural elements of the hook 300 have been described. In addition, various structural arrangements of features have been illustrated and described. It is to be understood, however, that any suitable dimensions and structural arrangements of features can be used to form a hook, and skilled artisans will be able to select suitable dimensions and structural arrangements of features for a hook according to a particular embodiment based on various considerations, including the intended use of the hook. For example, each dimension can alternatively be a dimension that is equal to, substantially equal to, about, greater than, less than, or near, the dimension described.

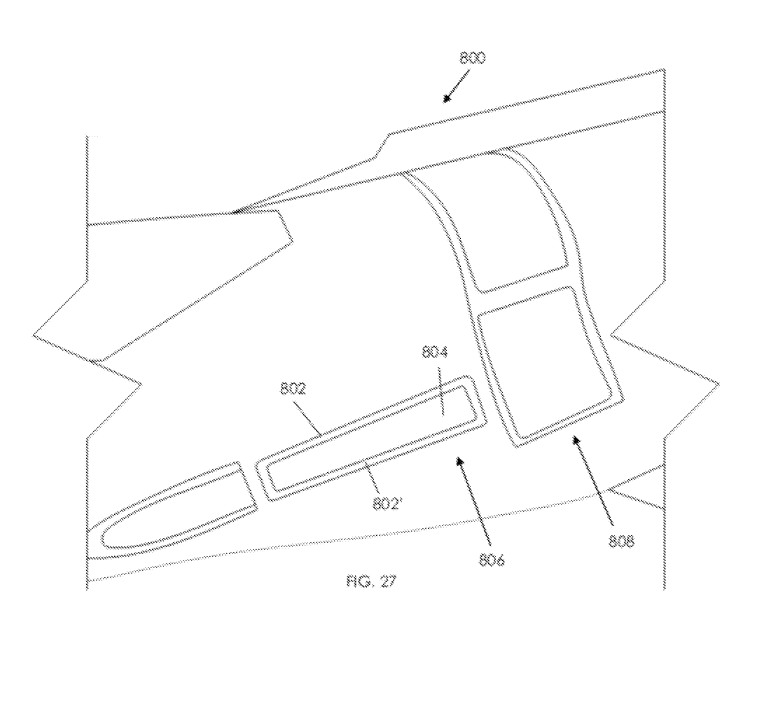

FIGS. 19 and 20 illustrate the hook 300 releasably attached to the multipurpose mat 210. In use, the projection 258 is introduced into recess 316 defined by hook 300 and the hook 300 is advanced into multipurpose mat 210 until the second side 306 of the hook 300 contacts the end of the first recess 250 and second recess 252. In the illustrated embodiment, the hook 300 is formed of a first material and the multipurpose mat 210 is formed of a second material. The first material is different from the second material and is relatively more rigid than the second material (e.g., the first material has a durometer hardness that is greater than the durometer hardness of the second material). Alternatively, the first material can be the same as the second material. While multipurpose mat 210 and hook 300 have been described as separate elements, a multipurpose mat and hook can be formed as integral components.

In the illustrated embodiment, a portion of hook 300 extends from the second surface 224 of multipurpose mat 210 a length 301′. Length 301′ can comprise any suitable distance and skilled artisans will be able to select a suitable distance for a hook to extend from the second surface of a multipurpose mat when attached to the multipurpose mat according to a particular embodiment based on various considerations, including the structural arrangement of an intended workspace. Example lengths considered suitable for a hook to extend from the second surface of a multipurpose mat include lengths equal to 0.125 inches, equal to about 0.125 inches, about 0.125 inches, greater than 0.125 inches, less than 0.125 inches, and any other length considered suitable for a particular embodiment. For example, as illustrated in FIG. 27, a jet 800 has a gun opening 802 that has a recessed edge 802′ that is recessed relative to the outer surface of the jet 800. When hook 300 extends from the second surface 224 it can be sized and configured to be disposed entirely within, or partially within, recessed edge 802′ to provide support for the multipurpose mat 300.

In the illustrated embodiment, example dimensions for various structural elements of the multipurpose mat 210 and hook 300 have been described. In addition, various structural arrangements of features have been illustrated and described. It is to be understood, however, that any suitable dimensions and structural arrangements of features can be used to form a multipurpose mat and/or hook, and skilled artisans will be able to select suitable dimensions and structural arrangements of features for a multipurpose mat and/or hook according to a particular embodiment based on various considerations, including the intended use of the multipurpose mat and/or hook. For example, each dimension can alternatively be a dimension that is equal to, substantially equal to, about, greater than, less than, or near, the dimension described.

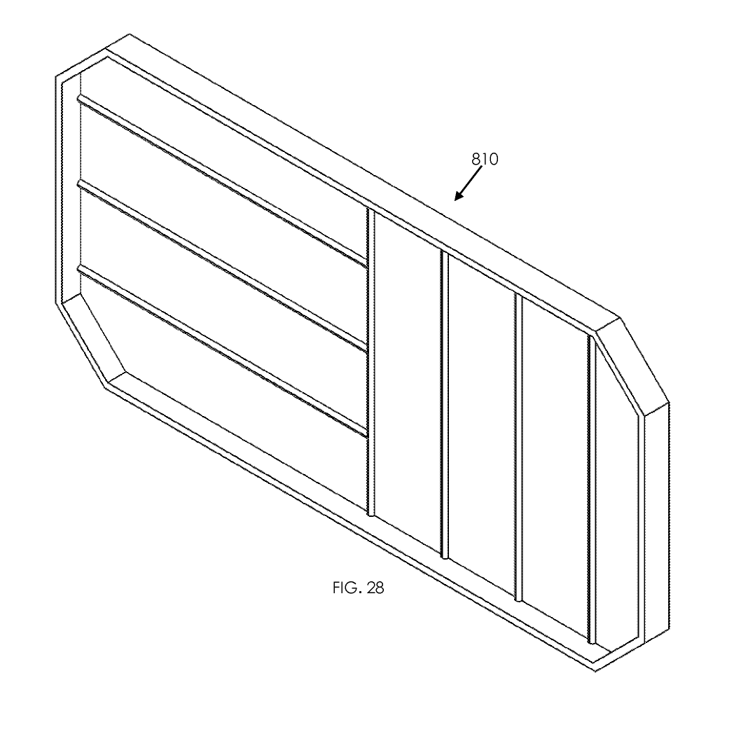

Each of FIGS. 21, 22, 23, and 24 illustrates another example embodiment of a multipurpose mat 610. Multipurpose mat 610 is similar to multipurpose mat 210 illustrated in FIGS. 8, 9, 10, 11, 12, 13, and 14 and described above, except as detailed below. Reference numbers in FIGS. 21, 22, 23, and 24 refer to the same structural element or feature referenced by the same number in FIGS. 8, 9, 10, 11, 12, 13, and 14, offset by 400. Thus, multipurpose mat 610 comprises a lengthwise axis 611 and a body 612 that defines a first side 614, a second side 616, a third side 618, a fourth side 620, a first surface 622, a second surface 624, and projections 626.

In the illustrated embodiment, the body 612 omits the inclusion of a first recess and a second recess and defines a first projection 640 and a plurality of second projections 642. A first set 642′ of the plurality of projections 642 extends from the first projection 640 to the edge between the first surface 622 and the second side 616 and a second set 642″ of the plurality of projections 642 extends from the edge between the first surface 662 and the fourth side 620 to edge between the first surface 622 and the second side 616.

In the embodiment illustrated, the second side 616 has a first length 617 that extends from the first side 614 to the third side 618 and the fourth side 620 has a second length 621 that extends from the first side 614 to the third side 618. The first length 617 is greater than the second length 221.

Each of FIGS. 25 and 26 illustrates another example embodiment of a multipurpose mat 710. Multipurpose mat 710 is similar to multipurpose mat 10 illustrated in FIGS. 1, 2, 3, and 4 and described above, except as detailed below. Reference numbers in FIGS. 25 and 26 refer to the same structural element or feature referenced by the same number in FIGS. 1, 2, 3, and 4, offset by 700. Thus, multipurpose mat 710 comprises a lengthwise axis 711 and a body 712 that defines a first side 714, a second side 716, a third side 718, a fourth side 720, a first surface 722, and a second surface 724.

In the illustrated embodiment, multipurpose mat 710 omits the inclusion of chamfers and the body 712 defines rounded corners 728. In addition, the body 712 of the multipurpose mat 710 defines a first projection 740, a second projection 742, and a plurality of projections 744 disposed between the first projection 740 and the second projection 742. Each of the first projection 740 and the second projection 742 extends from the first surface 722 and away from the second surface a first length and each projection of the plurality of projections 744 extends from the first surface 722 and away from the second surface a second length. The first length that is greater than the second length.

The first projection 740 extends along the edge of the first surface 722 and the second side 716 and extends along a portion of the edge of the first surface 722 and the first side 714 and along a portion of the edge of the first surface 722 and the third side 718. The second projection 742 extends along the edge of the first surface 722 and the fourth side 720 and extends along a portion of the edge of the first surface 722 and the first side 714 and along a portion of the edge of the first surface 722 and the third side 718.

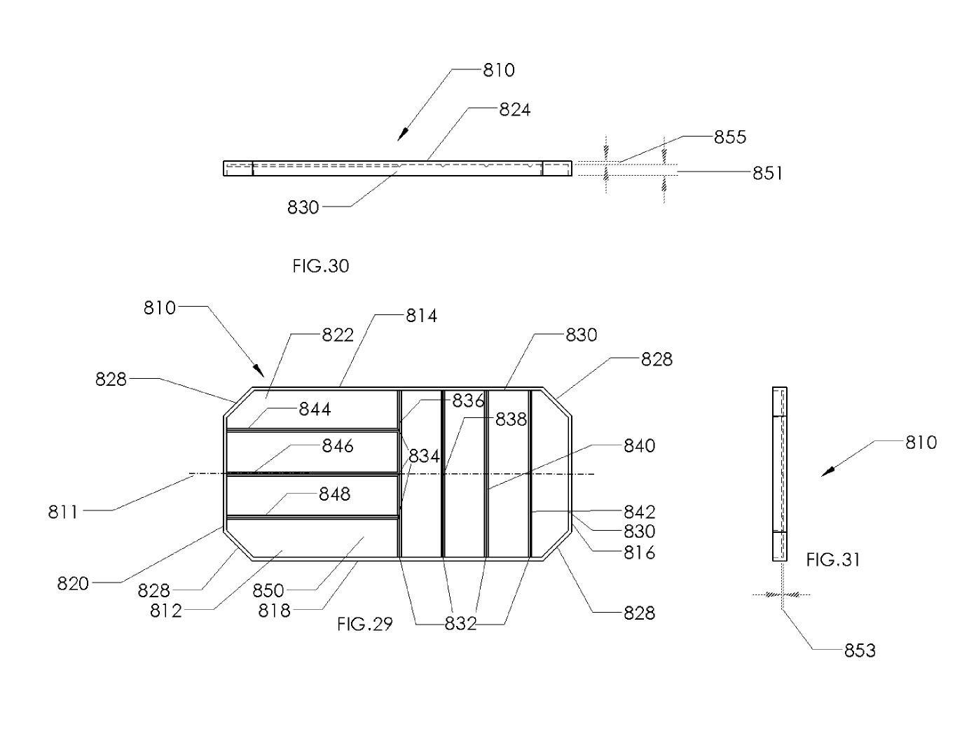

Each of FIGS. 28, 29, 30, and 31 illustrates another example embodiment of a multipurpose mat 810. Multipurpose mat 810 is similar to multipurpose mat 10 illustrated in FIGS. 1, 2, 3, and 4 and described above, except as detailed below. Reference numbers in FIGS. 28, 29, 30, and 31 refer to the same structural element or feature referenced by the same number in FIGS. 1, 2, 3, and 4, offset by 800. Thus, multipurpose mat 810 comprises a lengthwise axis 811 and a body 812 that defines a first side 814, a second side 816, a third side 818, a fourth side 820, a first surface 822, and a second surface 824.

In the illustrated embodiment, the first surface 822 is opposably positioned from the second surface 824 such that the multipurpose mat 810 has a thickness that extends from the first surface 822 to the second surface 824 that is equal to about 0.25 inches. The length of the multipurpose mat 810 that extends from the second side 816 to the fourth side 820, including the length of chamfers 828, is equal to about 24 inches. The length of the multipurpose mat 810 that extends from the first side 814 to the third side 818, including the length of chamfers 828, is equal to about 12 inches.

In the illustrated embodiment, alternative to defining projections, such as those illustrated in FIGS. 1, 2, 3, and 4 (e.g., projections 26), multipurpose mat 810 defines a wall 830, a first set of projections 832, and a second set of projections 834. The wall 830 extends from the first surface 822 and away from the second surface 824 a first distance 851. In the illustrated embodiment, the first distance 851 is equal to about 0.75 inches. However, other distances are considered suitable. The wall 830 has a thickness equal to about 0.25 inches and extends about the entire perimeter of the first surface 822 of the multipurpose mat 810 such that a first portion of the wall 830 extends along the first side 814, a second portion of the wall 830 extends along the second side 816, a third portion of the wall 830 extends along the third side 818, and a fourth portion of the wall 830 extends along the fourth side 820. However, alternative embodiments can include a wall that extends along a portion of the perimeter of a first surface. In the illustrated embodiment, the first portion of the wall 830 that extends along the first side 814 has an outer surface that is coplanar with the first side, the second portion of the wall 830 that extends along the second side 816 has an outer surface that is coplanar with the second side 816, the third portion of the wall 830 that extends along the third side 818 has an outer surface that is coplanar with the third side 818, and the fourth portion of the wall 830 that extends along the fourth side 820 has an outer surface that is coplanar with the fourth side 820. Alternatively, the wall of a multipurpose mat can be disposed along a portion of the perimeter of a surface or can be entirely disposed on the first surface such that is does not contact an edge of a multipurpose mat.

The structural arrangement of the wall 830 defines a cavity 850 that is sized and configured to house one or more objects, tools, and/or devices, such as a cellular phone (e.g., iPhone).

Each projection of the first set of projections 832 extends from the first surface 822 and away from the second surface 824 a second distance 853. In the illustrated embodiment, the second distance 853 is less than the first distance 851 and is equal to about 0.13 inches. Each projection of the first set of projections 832 extends from the first portion of the wall 830 that extends along the first side 814 to the third portion of the wall 830 that extends along the third side 818. In the embodiment illustrated, a first projection 836 of the first set of projections 832 is disposed on a first axis, a second projection 838 of the first set of projections 832 is disposed on a second axis, a third projection 840 of the first set of projections 832 is disposed on a third axis, and a fourth projection 842 of the first set of projections 832 is disposed on a fourth axis. The first axis is disposed orthogonal to a plane that contains the lengthwise axis 811 and is parallel to the second axis, third axis, and the fourth axis. Thus, the first projection 836, the second projection 838, the third projection 840, and the fourth projection 842 are parallel to one another. However, alternative embodiments can include a first projection that is disposed on a first axis that is not disposed orthogonal to a plane that contains the lengthwise axis of a multipurpose mat and/or that is not parallel to a second axis, third axis, and/or fourth axis.

In the illustrated embodiment, each projection of the first set of projections 832 has a thickness equal to about 0.25 inches as measured on an axis that is parallel to the lengthwise axis 811 of the multipurpose mat 810. The first projection 836 is separated from the adjacent second projection 838 by a distance equal to about 2.75 inches. The second projection 838 is separated from the adjacent third projection 840 by a distance equal to about 2.75 inches. The third projection 840 is separated from the adjacent fourth projection 842 by a distance equal to about 2.75 inches. The fourth projection 842 is separated from the adjacent wall 830 (e.g., second portion of the wall 830 that extends along the second side 816) by a distance equal to about 2.5 inches.

Each projection of the second set of projections 834 extends from the first surface 822 and away from the second surface 824 a third distance 855 that is less than the first distance 851. Each projection of the second set of projections 834 extends from the fourth portion of the wall 830 that extends along the fourth side 820 to the first projection 836 of the first set of projections 832. In the embodiment illustrated, a first projection 844 of the second set of projections 834 is disposed on a first axis, a second projection 846 of the second set of projections 834 is disposed on a second axis, and a third projection 848 of the second set of projections 834 is disposed on a third axis. The first axis is disposed parallel to the second axis and the third axis. Thus, the first projection 844, the second projection 846, and the third projection 848 are parallel to one another. However, alternative embodiments can include a first projection that is disposed on a first axis that is not parallel to a second axis and/or third axis. Each of the first projection 844, second projection 846, and third projection 848 of the second set of projections 834 is disposed at an angle to the first projection 836 of the first set of projections 832. In the illustrated embodiment, the first projection 844, second projection 846, and third projection 848 of the second set of projections 834 is disposed at an orthogonal angle to the first projection 836 of the first set of projections 832. Alternatively, each of the first projection, second projection, and/or third projection of a second set of projections can be disposed at other angles relative to the first projection of a first set of projections (e.g., 45 degrees), or a projection included on a multipurpose mat can be curved.

In the illustrated embodiment, each projection of the second set of projections 834 has a thickness equal to about 0.25 inches as measured on an axis that is disposed on a plane that is orthogonal to the lengthwise axis 811. The first projection 844 is separated from the adjacent wall 830 (e.g., fourth portion of the wall 830 that extends along the fourth side 820) by a distance equal to about 2.63 inches. The first projection 844 is separated from the adjacent second projection 846 by a distance equal to about 2.75 inches. The second projection 846 is separated from the adjacent third projection 848 by a distance equal to about 2.75 inches.

In the embodiment illustrated, the first distance 851 the wall 830 extends from the first surface 822 and away from the second surface 824 is greater than the second distance 853 the first set of projections 832 extends from the first surface 822 and the third distance 855 the second set of projections 834 extends from the first surface 822. The wall 830, each projection of the first set of projections 832, and each projection of the second set of projections 834, has a rounded outer surface. For example, each projection of the first set of projections 832 and each projection of the second set of projection 834 can have a radius of curvature at its apex that is equal to about 0.13 inches. Alternatively, the wall, each projection of the first set of projections, and/or each projection of the second set of projections included on a multipurpose mat can have any suitable cross-sectional configuration, such as rectangular, square, or curved.

While the first set of projections 832 has been illustrated as having four projections and the second set of projections 834 has been illustrated as having three projections, the first set of projections and second set of projections included on a multipurpose mat can include any suitable number of projections. Skilled artisans will be able to select a suitable number of projections to include on a multipurpose mat according to a particular embodiment based on various considerations, including the intended use of the multipurpose mat. Example number of projections considered suitable to include in a first and/or second set of projections included on a multipurpose mat include one, at least one, two, a plurality, three, four, five, and any other number considered suitable for a particular embodiment. Alternative embodiments can omit the inclusion of the first set of projections and/or second set of projections.

In the illustrated embodiment, the multipurpose mat 810 is formed of a pliable material such that the multipurpose mat 810 can be moved between a first, open, configuration in which the first portion of the wall 830 that extends along the first side 814 and the third portion of the wall 830 that extends along the third side 818 are parallel to one another and do not contact one another and a second, closed, configuration in which the first portion of the wall 830 that extends along the first side 814 contacts the third portion of the wall 830 that extends along the third side 818. Alternatively, or in combination with the configuration described above, the multipurpose mat 810 can be formed of a pliable material such that the multipurpose mat 810 can be moved between a first, open, configuration in which the second portion of the wall 830 that extends along the second side 816 and the fourth portion of the wall 830 that extends along the fourth side 820 are parallel to one another and do not contact one another and a second, closed, configuration in which the second portion of the wall 830 that extends along the second side 816 contacts the fourth portion of the wall 830 that extends along the fourth side 820. For example, a multipurpose mat can be formed of a pliable material such that the multipurpose mat can be folded. In the second configuration, the second surface of a multipurpose mat will form a teardrop configuration. For example, when the first portion of the wall 830 that extends along the first side 814 and the third portion of the wall 830 that extends along the third side 818 are brought into contact with one another, each of the second and fourth portions of the wall 830 will be curved and form a teardrop configuration. Alternatively, when the second portion of the wall 830 that extends along the second side 816 and the fourth portion of the wall that extends along the fourth side 820 are brought into contact with one another, each of the first and third portions of the wall 830 will be curved and form a teardrop configuration.

A multipurpose mat, such as those that are formed of a pliable material, can optionally include one or more locking mechanism that are configured to lock the multipurpose mat in the second configuration. A multipurpose mat can include any suitable locking mechanism and skilled artisans will be able to select a suitable locking mechanism to include on a multipurpose mat according to a particular embodiment based on various considerations, including the material that forms the multipurpose mat. Example locking mechanisms considered suitable to include on a multipurpose mat include snap fit structures, one or more hook and loop elements, first and second elements that have corresponding interlocking teeth (e.g., zipper), one or more clasps, any combination of the locking mechanisms described herein, and any other locking mechanism considered suitable for a particular embodiment.

In the illustrated embodiment, example dimensions for various structural elements of the multipurpose mat 810 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described.

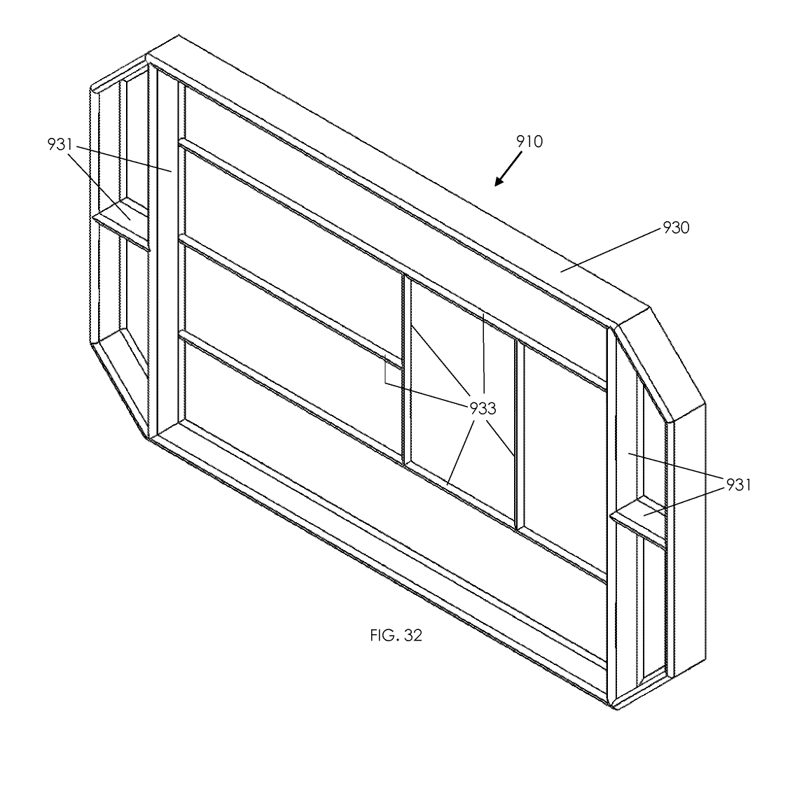

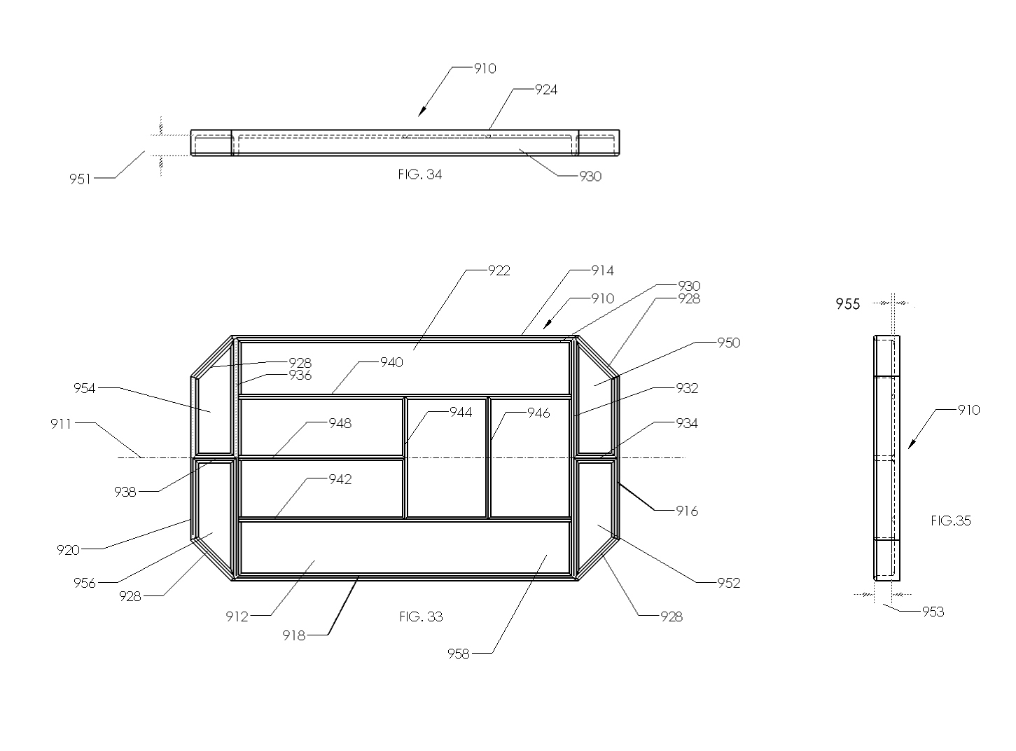

Each of FIGS. 32, 33, 34, and 35 illustrates another example embodiment of a multipurpose mat 910. Multipurpose mat 910 is similar to multipurpose mat 810 illustrated in FIGS. 28, 29, 30, and 31 and described above, except as detailed below. Reference numbers in FIGS. 32, 33, 34, and 35 refer to the same structural element or feature referenced by the same number in FIGS. 28, 29, 30, and 31, offset by 100. Thus, multipurpose mat 910 comprises a lengthwise axis 911 and a body 912 that defines a first side 914, a second side 916, a third side 918, a fourth side 920, a first surface 922, and a second surface 924.

In the embodiment illustrated, the multipurpose mat 910 defines a wall 930, a first set of projections 931, and a second set of projections 933. The first set of projections 931 comprises a first projection 932, a second projection 934, a third projection 936, and a fourth projection 938. The second set of projections 933 comprises a fifth projection 940, a sixth projection 942, a seventh projection 944, an eighth projection 946, and a ninth projection 948. Each projection of the first set of projections 931 and each projection of the second set of projections 933 extends from the first surface 922 and away from the second surface 924. In the illustrated embodiment, each projection of the first set of projections 931 and second set of projections 933 has a thickness equal to about 0.25 inches.

The first surface 922 is opposably facing the second surface 924 such that the multipurpose mat 910 has a thickness equal to about 0.25 inches. The length of the multipurpose mat 910 that extends from the second side 916 to the fourth side 920 is equal to about 21 inches. The length of the multipurpose mat 910 that extends from the first side 914 to the third side 918 is equal to about 12 inches.

The wall 930 extends from the first surface 922 and away from the second surface 924 a first distance 951. In the illustrated embodiment, the first distance 951 is equal to about 1.0 inch. The wall 930 extends about the entire perimeter of the first surface 922 of the multipurpose mat 910 such that a first portion of the wall 930 extends along the first side 914, a second portion of the wall 930 extends along the second side 916, a third portion of the wall 930 extends along the third side 918, and a fourth portion of the wall 930 extends along the fourth side 920. Alternatively, the wall of a multipurpose mat can be disposed along a portion of the perimeter of a surface or can be entirely disposed on the first surface such that is does not contact an edge of a multipurpose mat.

Each of the first projection 932, second projection 934, third projection 936, and fourth projection 938 extends from the first surface 922 and away from the second surface 924 a second distance 953. In the illustrated embodiment, the second distance 953 is equal to the first distance 951. Alternatively, the second distance 953 can be substantially equal to, about, greater than, or less than the first distance 951.

Each of the first projection 932 and the third projection 936 extends from the first portion of the wall 930 that extends along the first side 914 to the third portion of the wall 930 that extends along the third side 918. Alternatively, the first projection and/or third projection included on a multipurpose mat can extend from a chamfer, or other feature included on a multipurpose mat. In the illustrated embodiment, the first projection 932 and the third projection 934 are parallel and disposed orthogonally to the first portion of the wall 930 that extends along the first side 914. However, alternative embodiments can include a first projection and third projection that are not parallel to one another and/or that extends at other angles relative to the first portion of a wall that extends along the first side.

The second projection 934 extends from the first projection 932 to the second portion of the wall 930 that extends along the second side 916. The fourth projection 938 extends from the third projection 936 to the fourth portion of the wall 930 that extends along the fourth side 920. In the illustrated embodiment, the second projection 934 and the fourth projection 936 are coplanar such that the lengthwise axis of the second projection 934 is coplanar with the lengthwise axis of the fourth projection 938. The second projection 934 is disposed orthogonal to the first projection 932 and the fourth projection 938 is disposed orthogonal to the third projection 936. However, alternative embodiments can include a second projection and a fourth projection that are not coplanar, a second projection that is not orthogonal to a first projection, and/or a fourth projection that is not orthogonal to a third projection. In the illustrated embodiment, the second projection 934 and the fourth projection 938 are disposed from the first side 914 a distance equal to about 6.0 inches.

The structural arrangement of the wall 930, the first projection 932, and the second projection 934 define a first cavity 950 and a second cavity 952. The first cavity 950 is adjacent to the second cavity 952. Each of the first cavity 950 and second cavity 952 is sized and configured to house one or more objects, tools, and/or devices, such as a cellular phone (e.g., iPhone). The structural arrangement of the wall 930, the third projection 936, and the fourth projection 938 define a third cavity 954 and a fourth cavity 956. The third cavity 954 is adjacent to the fourth cavity 956. Each of the third cavity 954 and fourth cavity 956 is sized and configured to house one or more objects, tools, and/or devices, such as a cellular phone (e.g., iPhone). The structural arrangement of the wall 930, the first projection 932 and the third projection 936 define a fifth cavity 958 that is adjacent to the first cavity 950, second cavity 952, third cavity 954, and fourth cavity 956. The fifth cavity 958 that is sized and configured to house one or more objects, tools, and/or devices, such as a cellular phone.

Each of the fifth projection 940, the sixth projection 942, the seventh projection 944, the eighth projection 946, and the ninth projection 948 extends from the first surface 922 and away from the second surface 924 a third distance 955. The third distance 955 is less than the first distance 951 and the second distance 953. In the illustrated embodiment, the third distance 955 is equal to about 0.13 inches. Alternatively, the third distance 955 can be substantially equal to, about, greater than, or less than the first distance 951 and/or second distance 953.

Each of the fifth projection 940 and sixth projection 942 extends from the first projection 932 to the third projection 936. In the illustrated embodiment, the fifth projection 940 is parallel to the sixth projection 942 and the lengthwise axis 911 of the multipurpose mat 910. The fifth projection 940 is disposed orthogonal to the first projection 932. The fifth projection 940 is disposed a distance from the first portion of the wall 930 that extends along the first side 914 that is equal to about 2.75 inches. In addition, the fifth projection 940 is disposed a distance from the sixth projection 942 that is equal to about 6.0 inches. However, alternative embodiments can include a fifth projection that is not parallel to a sixth projection, a fifth projection that is not orthogonal to a first projection, and/or a fifth projection that is not parallel to the lengthwise axis of a multipurpose mat.

Each of the seventh projection 944 and eighth projection 946 extends from the fifth projection 940 to the sixth projection 942. In the illustrated embodiment, the seventh projection 944 and the eighth projection 946 are parallel to one another and are disposed orthogonal to the fifth projection 940 and the sixth projection 942. The seventh projection 944 is disposed from the fourth portion of the wall 930 that extends along the fourth side 920 a distance equal to about 10.5 inches. A length equal to about 4.0 inches separates the seventh projection 944 and the eighth projection 946. However, alternative embodiments can include a seventh projection that is not parallel to an eighth projection, a seventh projection that is not disposed orthogonal to a fifth projection, and/or an eighth projection that is not disposed orthogonal to a fifth projection.

The ninth projection 948 extends from the third projection 936 to the seventh projection 944 and is disposed parallel to the fifth projection 940 and the sixth projection 942. However, alternative embodiments can include a ninth projection that is not parallel to a fifth projection.

While the projections illustrated in FIGS. 32, 33, 34, and 35 have been illustrated as being disposed in a particular configuration, the projections defined by the body of a multipurpose mat can be arranged in any suitable configuration. Skilled artisans will be able to select a suitable configuration for one or more projections defined by the body of a multipurpose mat according to a particular embodiment based on various considerations, including the dimensions of a component intended to be disposed on a multipurpose mat (e.g., dimensions of a tool). Alternatively, multipurpose mat 910 can omit the inclusion of one or more of the illustrated projections. For example multipurpose mat 910 can omit the inclusion of one or more of the first projection 932, the second projection 934, the third projection 936, the fourth projection 938, the fifth projection 940, the sixth projection 942, the seventh projection 944, the eighth projection 946, and/or the ninth projection 948.

In the illustrated embodiment, example dimensions for various structural elements of the multipurpose mat 910 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described.

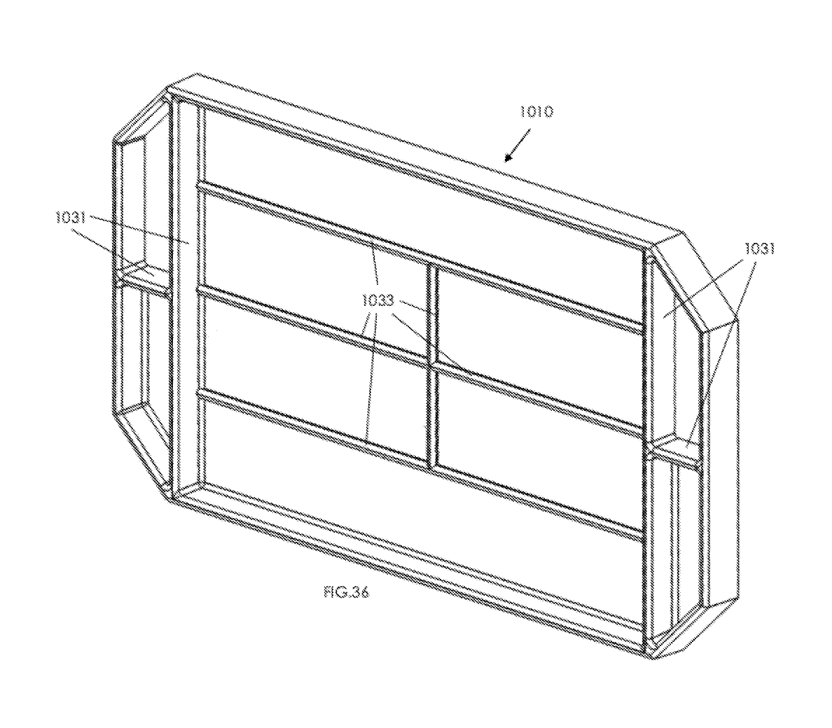

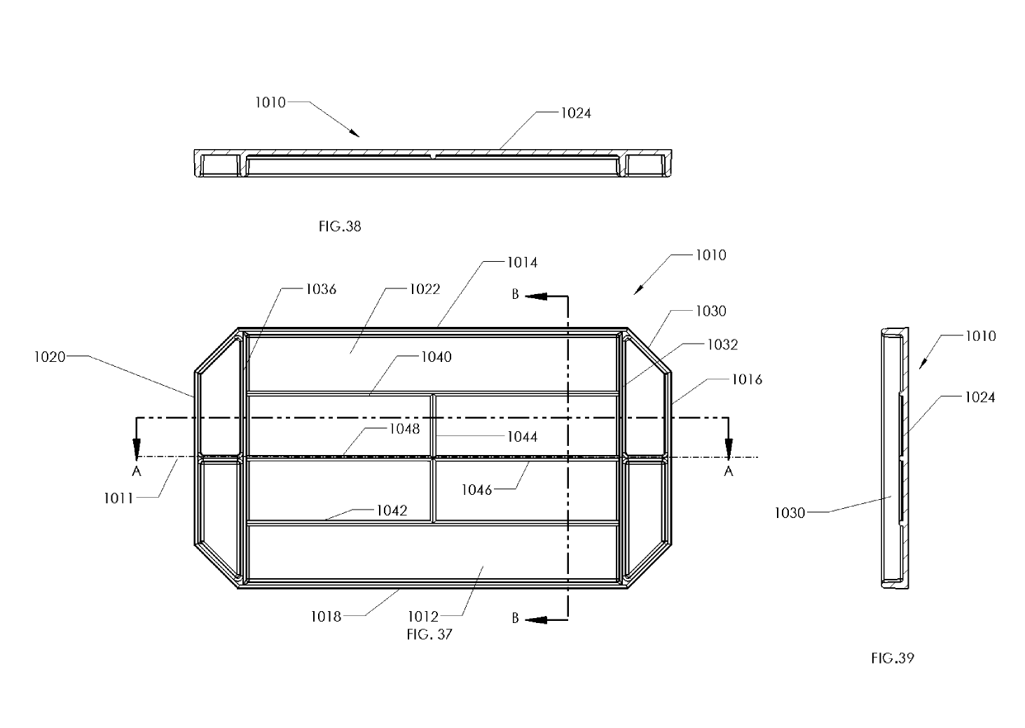

Each of FIGS. 36, 37, 38, and 39 illustrates another example embodiment of a multipurpose mat 1010. Multipurpose mat 1010 is similar to multipurpose mat 910 illustrated in FIGS. 32, 33, 34, and 35 and described above, except as detailed below. Reference numbers in FIGS. 36, 37, 38, and 39 refer to the same structural element or feature referenced by the same number in FIGS. 32, 33, 34, and 35, offset by 100. Thus, multipurpose mat 1010 comprises a lengthwise axis 1011 and a body 1012 that defines a first side 1014, a second side 1016, a third side 1018, a fourth side 1020, a first surface 1022, a second surface 1024, a first set of projections 1031, and a second set of projections 1033.

In the illustrated embodiment, the length of the multipurpose mat 1010 that extends from the second side 1016 to the fourth side 1020 is equal to about 22.0 inches. The length of the multipurpose mat 1010 from the first side 1014 to the third side 1018 is equal to about 12 inches.

In the illustrated embodiment, the eighth projection 1046 extends from the seventh projection 1044 to the first projection 1032, is disposed parallel to the fifth projection 1040, and is coplanar with the ninth projection 1048. However alternative embodiments, can include an eighth projection that is not parallel with a fifth projection and/or that is not coplanar with a ninth projection.

In the illustrated embodiment, the thickness of each projection of the first set of projections 1031 tapers from the first surface 1022 and away from the second surface 1024. The first projection 1032 is disposed from the second portion of the wall 1030 that extends along the second side 1016 a distance equal to about 2.1 inches. The third projection 1036 is disposed from the fourth portion of the wall 1030 that extends along the fourth side 1020 a distance equal to about 2.1 inches. The first projection 1032 is separated from the third projection 1036 a distance equal to about 17.54 inches. The seventh projection 1044 is separated from the second portion of the wall 1030 that extends along the second side 1016 a distance equal to about 11.0 inches.

In the illustrated embodiment, example dimensions for various structural elements of the multipurpose mat 1010 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described. For example, any portion of a wall and/or a projection can include a base that is adjacent to the first surface that has a thickness greater than the free edge of the wall or projection.

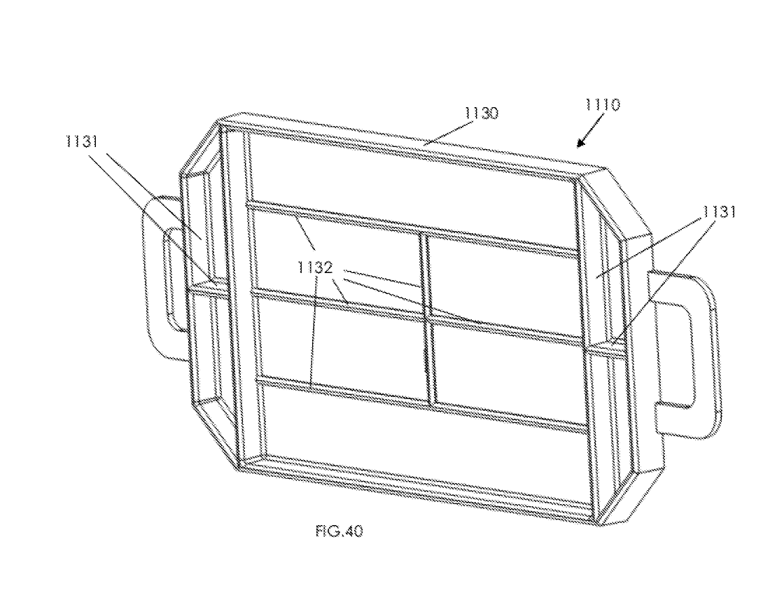

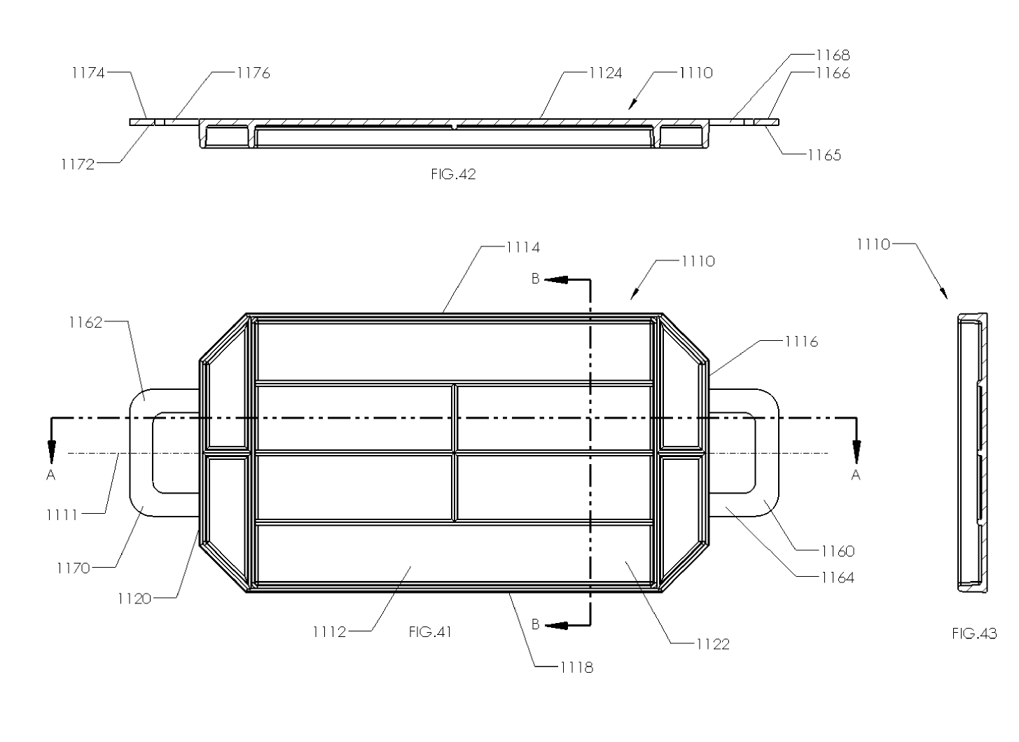

Each of FIGS. 40, 41, 42, and 43 illustrates another example embodiment of a multipurpose mat 1110. Multipurpose mat 1110 is similar to multipurpose mat 1010 illustrated in FIGS. 36, 37, 38, and 39 and described above, except as detailed below. Reference numbers in FIGS. 40, 41, 42, and 43 refer to the same structural element or feature referenced by the same number in FIGS. 36, 37, 38, and 39, offset by 100. Thus, multipurpose mat 1110 comprises a lengthwise axis 1111 and a body 1112 that defines a first side 1114, a second side 1116, a third side 1118, a fourth side 1120, a first surface 1122, a second surface 1124, a first set of projections 1131, and a second set of projections 1133.

In the illustrated embodiment, the multipurpose mat 1110 includes a first handle 1160 and a second handle 1162. The first handle 1160 is attached to the second side 1116 and the second handle 1162 is attached to the fourth side 1120. However, alternative embodiments can include a handle attached to the first side, the second side, the third side, and/or the fourth side.

The first handle 1160 extends from the second side 1116 away from the fourth side 1120 and has a body 1164 that defines a first surface 1165, a second surface 1166, and an opening 1168 that is sized and configured to receive a portion of a user's hand. In the illustrated embodiment, the second surface 1166 of the first handle 1160 is coplanar with the second surface 1124 of the multipurpose mat 1110. However, alternative embodiments can include a handle that is positioned on any suitable portion of a second side (e.g., such that it is not coplanar with the second surface of the multipurpose mat) and that has any suitable cross-sectional configuration, such as circular, square, rectangular, curved, and any other cross-sectional configuration considered suitable for a particular embodiment. The first handle 1160 has a thickness that extends from the first surface 1165 to the second surface 1166 that is equal to 0.25 inches.

The second handle 1162 extends from the fourth side 1120 away from the second side 1116 and has a body 1170 that defines a first surface 1172, a second surface 1174, and an opening 1176 that is sized and configured to receive a portion of a user's hand. In the illustrated embodiment, the second surface 1174 of the second handle 1162 is coplanar with the second surface 1124 of the multipurpose mat 1110. However, alternative embodiments can include a handle that is positioned on any suitable portion of a fourth side (e.g., such that it is not coplanar with the second surface of the multipurpose mat) and that has any suitable cross-sectional configuration, such as circular, square, rectangular, curved, and any other cross-sectional configuration considered suitable for a particular embodiment. The second handle 1162 has a thickness that extends from the first surface 1172 to the second surface 1174 that is equal to 0.25 inches.

In the illustrated embodiment, the first handle 1160 and the second handle 1162 are formed of the same material as the multipurpose mat 1110 (e.g., rubber). However, alternative embodiments can include a first handle and/or second handle that is formed of a first material that is different than a second material that forms a multipurpose mat.

In the illustrated embodiment, example dimensions for various structural elements of the multipurpose mat 1110 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described.

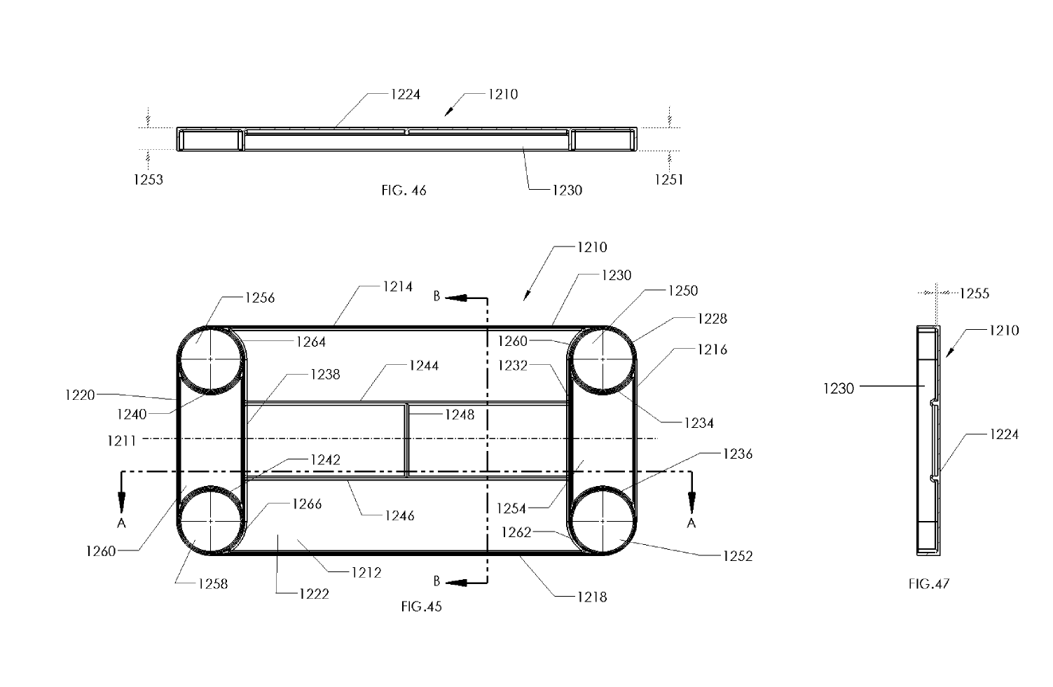

Each of FIGS. 44, 45, 46, and 47 illustrates another example embodiment of a multipurpose mat 1210. Multipurpose mat 1210 is similar to multipurpose mat 1010 illustrated in FIGS. 36, 37, 38, and 39 and described above, except as detailed below. Reference numbers in FIGS. 44, 45, 46, and 47 refer to the same structural element or feature referenced by the same number in FIGS. 36, 37, 38 and 39, offset by 200. Thus, multipurpose mat 1210 comprises a lengthwise axis 1211 and a body 1212 that defines a first side 1214, a second side 1216, a third side 1218, a fourth side 1220, a first surface 1222, a second surface 1224, a wall 1230, a first set of projections 1231, and a second set of projections 1233.

In the illustrated embodiment, the multipurpose mat 1210 includes rounded corners 1228. The wall 1230 extends from the first surface 1222 and away from the second surface 1224 a first distance 1251. The first set of projections 1231 includes a first projection 1232, a second projection 1234, a third projection 1236, a fourth projection 1238, a fifth projection 1240, and a sixth projection 1242. The first set of projections 1231 extends from the first surface 1222 and away from the second surface 1224 a second distance 1253 that is equal to the first distance 1251.

Each of the first projection 1232 and the fourth projection 1238 extends from the first portion of the wall 1230 that extends along the first side 1214 to the third portion of the wall 1230 that extends along the third side 1218. Alternatively, the first projection 1232 and/or fourth projection 1238 can extend from a rounded corner 1228.

A first portion 1260 and a second portion 1262 of the first projection 1232 are curved. The first portion 1260 is curved such that the first projection 1232 extends toward a plane that contains the second portion of the wall 1230 that extends along the second side 1216. The second portion 1262 is curved such that the first projection 1232 extends toward a plane that contains the second portion of the wall 1230 that extends along the second side 1216. A first portion 1264 and a second portion 1266 of the fourth projection 1238 are curved. The first portion 1264 is curved such that the fourth projection 1238 extends toward a plane that contains the fourth portion of the wall 1230 that extends along the fourth side 1220. The second portion 1266 is curved such that the fourth projection 1238 extends toward a plane that contains the fourth portion of the wall 1230 that extends along the fourth side 1220. In the illustrated embodiment, the portions of the first projection 1232 and the fourth projection 1238 that are linear are disposed parallel to one another and are disposed orthogonal to a plane that contains the lengthwise axis 1211 of the multipurpose mat 1210.

Each of the second projection 1234 and the third projection 1236 extends from the first projection 1232 to the second portion of the wall 1230 that extends along the second side 1216. Each of the second projection 1234 and the third projection 1236 is curved. The second projection 1234 is curved such that it extends from the wall 1230 toward the third projection 1236 to a midpoint and from the midpoint and away from the third projection 1236 to the first projection 1232. The third projection 1236 is curved such that it extends from the wall 1230 toward the second projection 1234 to a midpoint and from the midpoint and away from the second projection 1234 to the first projection 1232.

In the illustrated embodiment, the wall 1230, the first projection 1232, and the second projection 1234 cooperatively define a first cavity 1250 and the wall 1230, the first projection 1232, and the third projection 1236 cooperatively define a second cavity 1252. In the illustrated embodiment, the first cavity 1250 has the same dimensions as the second cavity 1252 and each of the first cavity 1250 and the second cavity 1252 is cylindrical. Each of the first cavity 1250 and the second cavity 1252 is sized and configured to receive one or more objects, tools, parts, and/or devices, such as a pop can. For example, each of a first cavity and a second cavity defined by a multipurpose mat can have a diameter that is about, equal to, substantially equal to, greater than, or less than 2.5 inches.

The wall 1230, the first projection 1232, the second projection 1234, and the third projection 1236 cooperatively define a third cavity 1254 that is adjacent to the first cavity 1250 and the second cavity 1252. The third cavity 1254 is sized and configured to receive one or more objects, tools, parts, and/or devices, such as a cell phone. For example, a third cavity defined by a multipurpose mat can have length measured along an axis that is parallel to the lengthwise axis of the multipurpose mat that is about, equal to, substantially equal to, greater than, or less than 2.31 inches and a width measured along an axis that is disposed on a plane that is orthogonal to the lengthwise axis of the multipurpose mat that is about, equal to, substantially equal to, greater than, or less than 4.54 inches.

Each of the fifth projection 1240 and the sixth projection 1242 extends from the fourth projection 1238 to the fourth portion of the wall 1230 that extends along the fourth side 1220. Each of the fifth projection 1240 and the sixth projection 1242 is curved. The fifth projection 1240 is curved such that it extends from the wall 1230 toward the sixth projection 1242 to a midpoint and from the midpoint and away from the sixth projection 1242 to the fourth projection 1238. The sixth projection 1242 is curved such that it extends from the wall 1230 toward the fifth projection 1240 to a midpoint and from the midpoint and away from the fifth projection 1240 to the fourth projection 1238.

In the illustrated embodiment, the wall 1230, the fourth projection 1238, and the fifth projection 1240 cooperatively define a fourth cavity 1256 and the wall 1230, the fourth projection 1238, and the sixth projection 1242 cooperatively define a fifth cavity 1258. In the illustrated embodiment, the fourth cavity 1256 has the same dimensions as the fifth cavity 1258 and each of the fourth projection 1238 and the fifth projection 1240 is cylindrical. Each of the fourth cavity 1256 and the fifth cavity 1258 is sized and configured to receive one or more objects, tools, parts, and/or devices, such as a pop can. For example, each of a first cavity and a second cavity defined by a multipurpose mat can have a diameter that is about, equal to, substantially equal to, greater than, or less than 2.5 inches.

The wall 1230, the fourth projection 1238, the fifth projection 1240, and the sixth projection 1242 cooperatively define a sixth cavity 1260 that is adjacent to the fourth cavity 1256 and the fifth cavity 1258. The sixth cavity 1260 is sized and configured to receive one or more objects, tools, parts, and/or devices, such as a cell phone. For example, a sixth cavity defined by a multipurpose mat can have length measured along an axis that is parallel to the lengthwise axis of the multipurpose mat that is about, equal to, substantially equal to, greater than, or less than 2.31 inches and a width measured along an axis that is disposed on a plane that is orthogonal to the lengthwise axis of the multipurpose mat that is about, equal to, substantially equal to, greater than, or less than 4.54 inches.

The second set of projections 1233 comprises a seventh projection 1244, eighth projection 1246, and a ninth projection 1248. Each of the seventh projection 1244, eighth projection 1246, and ninth projection 1248 extends from the first surface 1222 and away from the second surface 1224 a third distance 1255. In the illustrated embodiment, the third distance 1255 is less than the first distance 1251 and the second distance 1253. Alternatively, the third distance 1255 can be substantially equal to, greater than, or less than the first distance 1251 and/or second distance 1253.

Each of the seventh projection 1244 and eighth projection 1246 extends from the first projection 1232 to the fourth projection 1238. The seventh projection 1244 and eighth projection 1246 are parallel to one another and to the lengthwise axis 1211 of the multipurpose mat 1210. The seventh projection 1244 and the eighth projection 1246 are disposed orthogonal to the first projection 1232. The ninth projection 1248 extends from the seventh projection 1244 to the eighth projection 1246 and is disposed orthogonal to the seventh projection 1244.

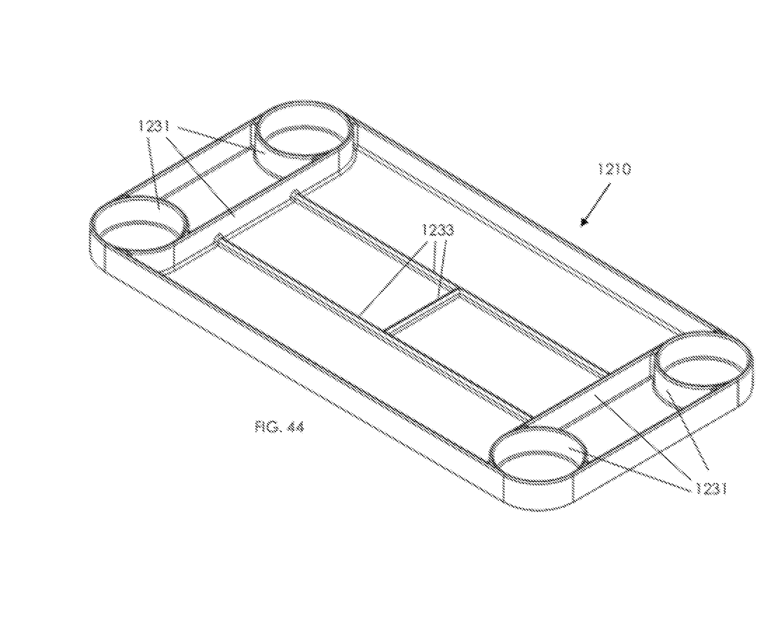

While the projections illustrated in FIGS. 42 and 43 have been illustrated as being disposed in a particular configuration, the projections defined by the body of a multipurpose mat can be arranged in any suitable configuration. Skilled artisans will be able to select a suitable configuration for one or more projections defined by the body of a multipurpose mat according to a particular embodiment based on various considerations, including the dimensions of a component intended to be disposed on a multipurpose mat (e.g., dimensions of a tool). Alternatively, multipurpose mat 1210 can omit the inclusion of one or more of the illustrated projections. For example multipurpose mat 1210 can omit the inclusion of one or more of the first projection 1232, the second projection 1234, the third projection 1236, the fourth projection 1238, the fifth projection 1240, the sixth projection 1242, the seventh projection 1244, the eighth projection 1246, and/or the ninth projection 1248.

In the illustrated embodiment, example dimensions for various structural elements of the multipurpose mat 1210 have been described. In addition, various structural arrangements of features have been illustrated and described. It is to be understood, however, that any suitable dimensions and structural arrangements of features can be used to form a multipurpose mat, and skilled artisans will be able to select suitable dimensions and structural arrangements of features for a multipurpose mat according to a particular embodiment based on various considerations, including the intended use of the multipurpose mat. For example, each dimension can alternatively be a dimension that is equal to, substantially equal to, about, greater than, less than, or near, the dimension described.

Any of the herein described multipurpose mats and/or hooks can include one or more magnets disposed within the body of the multipurpose mat and/or hook, or disposed on a surface of the body of the multipurpose mat and/or hook. The one or more magnets can be formed of any suitable material and be disposed at suitable location on, or within, a multipurpose mat and/or hook. For example, a first magnet can be disposed within the body, or on a surface, of a multipurpose mat and a second magnet can be disposed within the body, or on the surface, of the multipurpose mat. The first magnet can be opposably positioned from the second magnet relative to a plane that contains the lengthwise axis of the multipurpose mat. Alternatively, the first magnet can be opposably positioned from the second magnet relative to a plane that is disposed orthogonal to the lengthwise axis of a multipurpose mat.

Any of the embodiments described herein can be used for any suitable purpose, and skilled artisans will be able to select a suitable purpose for a multipurpose mat and/or a multipurpose mat and associated hook according to a particular embodiment based on various considerations, including the procedure intended to be completed. For example, FIG. 27 illustrates a jet 800 upon which an embodiment of a multipurpose mat or a multipurpose mat and associated hook, such as those described and illustrated herein, can be used.

Jet 800 has a gun opening 802 that provides access to a gun housing 804. In use, a multipurpose mat, such as the embodiment described and illustrated herein, can be disposed, for example, at location 806 or location 808 to provide footing and/or temporary storage for one or more objects, tools, and/or devices while maintenance is being provided to the jet 800. When placed at location 806 or 808 on the jet 800, the second surface of the multipurpose mat will conform to the structural arrangement of the surface on which the multipurpose mat is disposed and will provide releasable attachment of the multipurpose mat to the surface on which it is disposed. This is considered advantageous because it reduces, or eliminates, foreign object damage to the jet 800 while it is being maintained. Optionally, more than one multipurpose mat or multipurpose mat and associated hook can be used in combination. For example, a first multipurpose mat can be disposed at location 806 and a second multipurpose mat can be disposed at location 808. Optionally, when included, a hook can be disposed along a portion of the perimeter of an opening (e.g., gun opening 802) to provide attachment of a multipurpose mat near, or at, a workspace.

While an example use of the multipurpose mat or a multipurpose mat and associated hook has been described, a multipurpose mat or a multipurpose mat and associated hook can be used in any desired manner. Skilled artisans will be able to select a suitable use for a multipurpose mat or a multipurpose mat and associated hook according to a particular embodiment based on various considerations, including the procedure intended to be performed.

An example method of using a multipurpose mat is described below. While the method is described as a series of acts, it is to be understood and appreciated that the method is not limited by the order of acts described, as some acts may in accordance with these methods, be omitted, be repeated, or occur in different orders and/or concurrently with other acts described herein. The method includes a method of using a multipurpose mat. While some steps, optional steps, and/or alternative steps are exemplified by performing the method on an airfoil, the methods, steps, optional steps, and/or alternative steps described herein can also be used to perform one or more of the steps described herein on any other suitable surface, or to complete any other activity.

A first step comprises placing a multipurpose mat on a surface of a powered vehicle that is capable of flight, such as the airfoil of an airplane or jet, such that the second surface of the multipurpose mat confirms to the surface on which the multipurpose mat is placed. While a particular surface has been described, a multipurpose mat can be placed on any suitable surface. Another step comprises placing one or more objects, tools, and/or devices on the multipurpose mat such that the one or more objects, tools, and/or devices contact the first surface, a projection, and/or the wall of the multipurpose mat. Another step comprises using the one or more objects, tools, and/or devices to complete a task, procedure, or step. Optionally, this step can be repeated. An optional step comprises returning the one or more objects, tools, and/or devices to the multipurpose mat such that the one or more objects, tools, and/or devices contact the first surface, a projection, and/or the wall of the multipurpose mat. Optionally, this step can be repeated. Another step comprises removing the one or more objects, tools, and/or devices from the multipurpose mat such that it does not contact the multipurpose mat. Another step comprises removing the multipurpose mat from the surface of the powered vehicle that is capable of flight.

Those with ordinary skill in the art will appreciate that various modifications and alternatives for the described and illustrated embodiments can be developed in light of the overall teachings of the disclosure. Accordingly, the particular arrangements disclosed are intended to be illustrative only and not limiting as to the scope of the invention, which is to be given the full breadth of the appended claims and any and all equivalents thereof.

What is claimed is:

1. A multipurpose mat having a lengthwise axis and comprising:
a mat body formed of a pliable material, the mat body defining:
a first side, a second side, a third side, and a fourth side;
a first surface having a perimeter defined by the first side, the second side, the third side, and the fourth side;
a second surface opposably facing the first surface;
a wall extending about the perimeter of the first surface such that a first portion of the wall extends along the first side, a second portion of the wall extends along the second side, a third portion of the wall extends along the third side, and a fourth portion of the wall extends along the fourth side, the wall extending from the first surface and away from the second surface;
a first set of projections comprising a first projection, a second projection, a third projection, and a fourth projection, each projection of the first set of projections extending from the first surface and away from the second surface, each of the first projection and the second projection extending from the first portion of the wall to the third portion of the wall, the third projection extending from the first projection to the second portion of the wall, the fourth projection extending from the third projection to the fourth portion of the wall; and
a second set of projections comprising a fifth projection, a sixth projection, a seventh projection, an eighth projection, and a ninth projection, each projection of the second set of projections extending from the first surface and away from the second surface, each of the fifth projection and the sixth projection extending from the first projection to the second projection, the seventh projection extending from the fifth projection to the sixth projection, the eighth projection extending from the first projection to the seventh projection, and the ninth projection extending from the seventh projection to the second projection;
wherein the pliable material is flexible such that the multipurpose mat can be moved from an open configuration in which the second side and the fourth side are parallel and a closed configuration in which the multipurpose mat is folded on an axis that is orthogonal to said lengthwise axis and the second portion of the wall and the fourth portion of the wall contact one another.

2. The multipurpose mat of claim 1, wherein the wall extends from the first surface and away from the second surface a first distance;
wherein each projection of the first set of projections extends from the first surface and away from the second surface a second distance; and
wherein the first distance is equal to the second distance.

3. The multipurpose mat of claim 2, wherein each projection of the second set of projections extends from the first surface and away from the second surface a third distance that is less than the first distance.

4. The multipurpose mat of claim 1, wherein the first projection and the second projection are parallel.

5. The multipurpose mat of claim 4, wherein the third projection and the fourth projection are coplanar.

6. The multipurpose mat of claim 5, wherein the fifth projection, sixth projection, eighth projection, and ninth projection are parallel.

7. The multipurpose mat of claim 6, wherein the eighth projection and the ninth projection are coplanar.

8. The multipurpose mat of claim 1, wherein the wall, the first projection, and the third projection cooperatively define a first cavity and a second cavity;
wherein the wall, the second projection, and the fourth projection cooperatively define a third cavity and a fourth cavity; and
wherein the wall, the first projection, and the second projection cooperatively define a fifth cavity.

9. The multipurpose mat of claim 8, wherein the first cavity and the second cavity have the same dimensions; and
wherein the third cavity and the fourth cavity have the same dimensions.

10. The multipurpose mat of claim 1, further comprising a first handle and a second handle, the first handle attached to the second side and the second handle attached to the fourth side.

11. The multipurpose mat of claim 1, wherein the perimeter of the first surface is entirely defined by the first side, the second side, the third side, and the fourth side.

12. A multipurpose mat having a lengthwise axis and comprising:
a mat body formed of a pliable material, the mat body defining:
a first side, a second side, a third side, and a fourth side, the first side and the second side disposed parallel to one another, the third side and the fourth side disposed parallel to one another;
a first surface having a perimeter defined by the first side, the second side, the third side, and the fourth side;
a second surface opposably facing the first surface;
a wall extending about the entire perimeter of the first surface such that a first portion of the wall extends along the first side, a second portion of the wall extends along the second side, a third portion of the wall extends along the third side, and a fourth portion of the wall extends along the fourth side, the wall extending from the first surface and away from the second surface a first distance;
a first set of projections comprising a first projection, a second projection, a third projection, and a fourth projection, each projection of the first set of projections extending from the first surface and away from the second surface a second distance that is equal to the first distance, each of the first projection and the second projection extending from the first portion of the wall to the third portion of the wall, the first projection parallel to the second projection, the third projection extending from the first projection to the second portion of the wall, the fourth projection extending from the third projection to the fourth portion of the wall; and
a second set of projections comprising a fifth projection, a sixth projection, a seventh projection, an eighth projection, and a ninth projection, each projection of the second set of projections extending from the first surface and away from the second surface a third distance that is less than the first distance, each of the fifth projection and the sixth projection extending from the first projection to the second projection, the seventh projection extending from the fifth projection to the second sixth projection, the eighth projection extending from the first projection to the seventh projection, and the ninth projection extending from the seventh projection to the second projection;
wherein the pliable material is flexible such that the multipurpose mat can be moved from an open configuration in which the second side and the fourth side are parallel and a closed configuration in which the multipurpose mat is folded on an axis that is orthogonal to said lengthwise axis and the second portion of the wall and the fourth portion of the wall contact one another.

13. The multipurpose mat of claim 12, wherein the third projection and the fourth projection are coplanar.

14. The multipurpose mat of claim 13, wherein the fifth projection, sixth projection, eighth projection, and ninth projection are parallel.

15. The multipurpose mat of claim 14, wherein the eighth projection and the ninth projection are coplanar.

16. The multipurpose mat of claim 12, wherein the wall, the first projection, and the third projection cooperatively define a first cavity and a second cavity;
wherein the wall, the second projection, and the fourth projection cooperatively define a third cavity and a fourth cavity; and
wherein the wall, the first projection, and the second projection cooperatively define a fifth cavity.

17. The multipurpose mat of claim 16, wherein the first cavity and the second cavity have the same dimensions; and
wherein the third cavity and the fourth cavity have the same dimensions.

18. The multipurpose mat of claim 12, further comprising a first handle and a second handle, the first handle attached to the second side and the second handle attached to the fourth side.

19. The multipurpose mat of claim 12, wherein the perimeter of the first surface is entirely defined by the first side, the second side, the third side, and the fourth side.

20. A multipurpose mat having a lengthwise axis and comprising:
a mat body formed of a pliable material, the mat body defining:
a first side, a second side, a third side, and a fourth side, the first side and the second side disposed parallel to one another, the third side and the fourth side disposed parallel to one another;
a first surface having a perimeter defined by the first side, the second side, the third side, and the fourth side;
a second surface opposably facing the first surface;
a wall extending about the entire perimeter of the first surface such that a first portion of the wall extends along the first side, a second portion of the wall extends along the second side, a third portion of the wall extends along the third side, and a fourth portion of the wall extends along the fourth side, the wall extending from the first surface and away from the second surface a first distance;
a first set of projections comprising a first projection, a second projection, a third projection, and a fourth projection, each projection of the first set of projections extending from the first surface and away from the second surface a second distance that is equal to the first distance, each of the first projection and the second projection extending from the first portion of the wall to the third portion of the wall, the first projection parallel to the second projection, the third projection extending from the first projection to the second portion of the wall, the fourth projection extending from the third projection to the fourth portion of the wall, the third projection being coplanar with the fourth projection; and
a second set of projections comprising a fifth projection, a sixth projection, a seventh projection, an eighth projection, and a ninth projection, each projection of the second set of projections extending from the first surface and away from the second surface a third distance that is less than the first distance, each of the fifth projection and the sixth projection extending from the first projection to the second projection, the seventh projection extending from the fifth projection to the sixth projection, the eighth projection extending from the first projection to the seventh projection, the ninth projection extending from the seventh projection to the second projection, each of the fifth projection, the sixth projection, the eighth projection, and the ninth projection being parallel to one another;
a first handle and a second handle, the first handle attached to the second side and the second handle attached to the fourth side;
wherein the pliable material is flexible such that the multipurpose mat can be moved from an open configuration in which the second side and the fourth side are parallel and a closed configuration in which the multipurpose mat is folded on an axis that is orthogonal to said lengthwise axis and the second portion of the wall and the fourth portion of the wall contact one another;
wherein the wall, the first projection, and the third projection cooperatively define a first cavity and a second cavity, the first cavity and the second cavity having the same dimensions; and
wherein the wall, the second projection, and the fourth projection cooperatively define a third cavity and a fourth cavity, the third cavity and the fourth cavity having the same dimensions.
